(19) United States
(12) Patent Application Publication
(10) Pub. No.: US 2010/0095981 A1
(43) Pub. Date: Apr. 22, 2010

(54) SUBSTRATE PROCESSING APPARATUS AND SUBSTRATE PROCESSING METHOD

(75) Inventor: Yuji KAMIKAWA, Tosu City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/581,562

(22) Filed: Oct. 19, 2009

(30) Foreign Application Priority Data
Oct. 21, 2008 (JP) 2008-271273
Oct. 21, 2008 (JP) 2008-271274

(51) Int. Cl. C23G 1/02; B08B 3/00

(52) U.S. Cl. 134/3; 134/103.2

(57) ABSTRACT

Disclosed are a substrate processing apparatus and a substrate processing method to efficiently remove a resist residue of a substrate surface by using sulfuric acid without hydrogen peroxide solution that is not stable in a high temperature, or by using sulfuric acid together with hydrogen peroxide solution that is not stable in a high temperature. The substrate processing apparatus to process a substrate by using a first processing liquid including sulfuric acid and a second processing liquid including water includes a liquid-film forming device to form a liquid film of the first processing liquid maintained at a temperature higher than room temperature on at least one surface of the substrate, and a vapor/mist supply device to supply vapor or mist of the second processing liquid on the surface of the substrate on which the liquid film of the first processing liquid is formed. Further, the substrate processing apparatus to process a substrate within a processing chamber by using a first processing liquid including sulfuric acid and a second processing liquid including hydrogen peroxide solution includes a processing tank to store the first processing liquid at a temperature higher than room temperature, a substrate elevating mechanism to move the substrate up and down between the processing tank and the processing chamber, and a mist supply device to supply mist of the second processing liquid to a portion of the substrate in the vicinity of a liquid surface of the first processing liquid stored in the processing tank when the substrate is lifted from or immersed into the processing tank by the substrate elevating mechanism.

This application is based on and claims priority from Japanese Patent Application Nos. 2008-271273 and 2008-271274, filed on Oct. 21, 2008, with the Japanese Patent Office, the disclosure of which is incorporated herein in its entirety by reference.

### TECHNICAL FIELD

The present disclosure relates to a substrate processing apparatus and a substrate processing method to process a substrate by using sulfuric acid, or sulfuric acid and hydrogen peroxide solution. In particular, the present invention relates to a substrate processing apparatus and a substrate processing method to efficiently remove a resist residue of a substrate surface.

### BACKGROUND

Conventionally, a method for cleaning a substrate, such as a semiconductor wafer (hereinafter, referred to as “the wafer”), by using a mixture of sulfuric acid and hydrogen peroxide solution as cleaning liquid has been known. In particular, the resist attached to the wafer is sufficiently dissolved by Caro's acid (H₂SO₅, also referred to as peroxo acid) that is generated through mixing sulfuric acid and hydrogen peroxide solution, thereby cleaning the wafer (its principle will be described later).

A substrate processing apparatus to process a substrate by using the mixture of sulfuric acid and hydrogen peroxide solution will be described with reference to FIG. 12. FIG. 12 is a view schematically illustrating the configuration of a general substrate processing apparatus.

As shown in FIG. 12, the general substrate processing apparatus includes an internal tank 110 to receive the wafer for cleaning and an external tank 112 installed in the vicinity of internal tank 110 to receive liquid overflowed from internal tank 110. Further, the substrate processing apparatus includes a return pipe 114 to return the liquid within external tank 112 to internal tank 110. Return pipe 114 is provided with return pump 116 to flow the liquid within external tank 112 to internal tank 110, a damper 118 to reduce vibration of return pipe 114 itself, a heater 120 to heat the liquid passing through an inside of return pipe 114, and a filter 122 to filter the liquid passing through the inside of return pipe 114. Return pump 116, damper 118, heater 120, and filter 122 are installed in series, respectively. Further, the substrate processing apparatus includes a sulfuric-acid storage tank 124 to store sulfuric acid (H₂SO₄) and hydrogen-peroxide-solution storage tank 130 to store hydrogen peroxide solution (H₂O₂). Sulfuric acid and hydrogen peroxide solution are supplied into internal tank 110 by a sulfuric-acid supply pipe 128 and a hydrogen-peroxide-solution supply pipe 134, respectively. The supply of each chemical liquid is controlled by a sulfuric-acid supply valve 126 and hydrogen-peroxide-solution supply valve 132, respectively.

Next, a method for generating a mixture by the substrate processing apparatus will be described. In an initial state, internal tank 110 and external tank 112 are empty.

First, in a state where return pump 116 and heater 120 is off, sulfuric-acid supply valve 126 and hydrogen-peroxide-solution supply valve 132 are opened and sulfuric acid and hydrogen peroxide solution are simultaneously supplied from sulfuric-acid storage tank 124 and hydrogen-peroxide-solution storage tank 130 into internal tank 110. For example, the supply rate of the sulfuric acid is 25 l/min and the supply rate of the hydrogen peroxide solution is 5 l/min, and the ratio of the supply amount of the sulfuric acid to hydrogen peroxide solution is 5:1. The reason why the supply rate of sulfuric acid is sufficiently large with respect to that of hydrogen peroxide solution will be described later. Sulfuric acid and hydrogen peroxide solution are continuously supplied until internal tank 110 is fully filled and the liquid of internal tank 110 overflows to external tank 112.

Sulfuric acid and hydrogen peroxide solution are supplied to internal tank 110, and then sulfuric acid and hydrogen peroxide solution are mixed.

Here, there are two patterns for mixing sulfuric acid and hydrogen peroxide solution.

First, one pattern is the chemical reaction as below.

H₂SO₄+H₂O₂→H₂SO₄H₂O+O* Formula (1)

Active oxygen (O*) is generated by the reaction of Formula (1). The active oxygen is a strong oxidizing agent.

On the other hand, the other pattern is the chemical reaction as below.

H₂SO₄H₂O₂→H₂SO₅+H₂O Formula (2)

Caro's acid (also referred to as peroxo acid, H₂SO₅) is generated by the reaction of Formula (2). The Caro's acid is a strong oxidizing agent, like the active oxygen, but Caro's acid is more effective than the active oxygen in dissolving the organic materials, such as the resist attached to the wafer. That is, Caro's acid is generated through mixing sulfuric acid and hydrogen peroxide solution, thereby sufficiently peeling the resist attached to the wafer.

FIG. 13 is a graph in which the horizontal axis is a ratio (mole ratio) of sulfuric acid with respect to hydrogen peroxide solution and the vertical axis is a generation ratio of Caro's acid. As shown in FIG. 13, as the ratio (mole ratio) of sulfuric acid with respect to hydrogen peroxide solution increases, the generation ratio of Caro's acid increases and the resist attached to the wafer can be efficiently peeled. This is the reason why the ratio of the amount of sulfuric acid to hydrogen peroxide solution supplied to internal tank 110 is large, for example, 5:1.

After the supply of sulfuric acid and hydrogen peroxide solution to internal tank 110 is finished, return pump 116 is operated and the liquid within external tank 112 returns to internal tank 110 via return pipe 114. Further, the liquid overflows from internal tank 110 to external tank 112. As such, the liquid is circulated in the combination unit of internal tank 110 and external tank 112. Here, heater 120 is also operated at the same time so that the liquid passing return pipe 114 is heated. Therefore, the temperature of the liquid within internal tank 110 increases up to the appropriate temperature (for example, 100° to 150°) for cleaning the wafer.

Return pump 116 and heater 120 are operated until the temperature of the liquid within internal tank 110 increases up to the predetermined temperature. After this, return pump 116 and heater 120 turn off. Next, a plurality of wafers is immersed into internal tank 110 at the same time. The resist attached to the wafer is dissolved by the mixture of sulfuric acid and hydrogen peroxide solution, more specifically, Caro's acid generated through mixing sulfuric acid and hydrogen peroxide solution and the resist is peeled. Through the above way, a series of cleaning processes of the wafer are completed.

Japanese Laid-Open Patent Nos. 2000-164550 and 2008-041794 disclose the examples of the aforementioned substrate processing apparatus or substrate processing method for sufficiently generating Caro's acid that is useful for peeling the resist from the substrate by using sulfuric acid and hydrogen peroxide solution.

However, when performing the substrate processing for removing a resist residue of a substrate surface by using sulfuric acid and hydrogen peroxide solution as processing liquid, the following situations occur.

When the substrate is processed by using sulfuric acid, the cleaning effect increases if the temperature of sulfuric acid becomes high. Therefore, the temperature of sulfuric acid and hydrogen peroxide solution within a processing layer must be maintained at an appropriate temperature (for example, 100° C. to 150° C.) for cleaning the wafer. However, if hydrogen peroxide solution is maintained at the high temperature (for example, 100° C. or higher), hydrogen peroxide solution causes the chemical reaction represented below and dissolves. Therefore, hydrogen peroxide solution cannot be stably maintained in the mixed state with sulfuric acid and cannot stably generate active oxygen or Caro's acid. As a result, the cleaning effect deteriorates.

2H₂O₂→2H₂O+O₂ Formula (3)

Further, when the temperature of sulfuric acid and hydrogen peroxide solution is maintained at an appropriate temperature (for example, 100° to 150°) for cleaning the wafer, hydrogen peroxide solution dissolves by the reaction of Formula (3) and the concentration of hydrogen peroxide solution decrease. Therefore, hydrogen peroxide solution cannot be supplied with the predetermined concentration.

As a result, the cleaning effect cannot be improved by means of increasing the temperature.

### SUMMARY

According to one embodiment, there is provided a substrate processing apparatus to process a substrate by using a first processing liquid including sulfuric acid and a second processing liquid including water. The substrate processing apparatus includes a liquid-film forming device to form a liquid film of the first processing liquid maintained at a temperature higher than room temperature on at least one surface of the substrate, and a vapor/mist supply device to supply vapor or mist of the second processing liquid to the surface of the substrate on which the liquid film of the first processing liquid is formed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view schematically illustrating the configuration of a substrate processing apparatus according to the first and third embodiments.

FIG. 2 is a perspective view schematically illustrating the configuration of a substrate processing apparatus according to the first and third embodiments.

FIG. 3 is a flowchart illustrating a sequence of each process of a substrate processing method according to the first and third embodiments.

FIG. 4A is a cross-sectional view (1) schematically illustrating an internal view of a processing chamber in each process in a substrate processing method according to the first and third embodiments.

FIG. 4B is a cross-sectional view (2) schematically illustrating the inside of a processing chamber in each process in a substrate processing method according to the first and third embodiments.

FIG. 4C is a cross-sectional view (3) schematically illustrating the inside of a processing chamber in each process in a substrate processing method according to the first and third embodiments.

FIG. 5 is a view schematically illustrating the supply of vapor/mist of a second processing liquid to a portion of a lifted substrate in the vicinity of the liquid surface of a first cleaning liquid stored in a processing tank in a substrate processing method according to the first and third embodiments.

FIG. 6 is a view schematically illustrating the configuration of a substrate processing apparatus according to the second and fourth embodiments.

FIG. 7 is a flowchart illustrating a sequence of each process of a substrate processing method according to the second and fourth embodiments.

FIG. 8 is a cross-sectional view schematically illustrating the inside of a cup in each process of a substrate processing method according to the second and fourth embodiments.

FIG. 9 is a view schematically illustrating the supply of vapor or mist of a second processing liquid to a surface of a substrate on which a liquid film of a first processing liquid is formed in a substrate processing method according to the second and fourth embodiments.

FIG. 10 is a flowchart illustrating a sequence of each process of a substrate processing method according to the modification of the second and fourth embodiments.

FIG. 11 is a cross-sectional view schematically illustrating the inside of a cup in each process of a substrate processing method according to the modification of the second and fourth embodiments.

FIG. 12 is a view schematically illustrating the configuration of a general substrate processing apparatus.

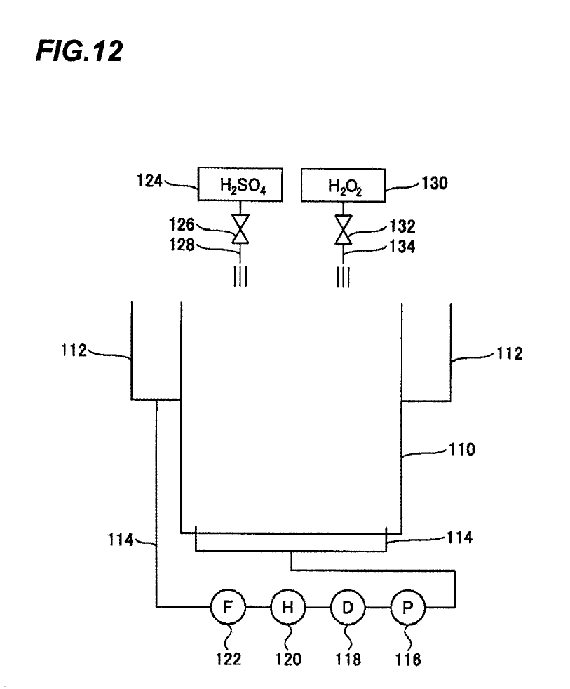

FIG. 13 is a graph in which the horizontal axis is a ratio (mole ratio) of sulfuric acid with respect to hydrogen peroxide solution and the vertical axis is a ratio of Caro's acid generation.

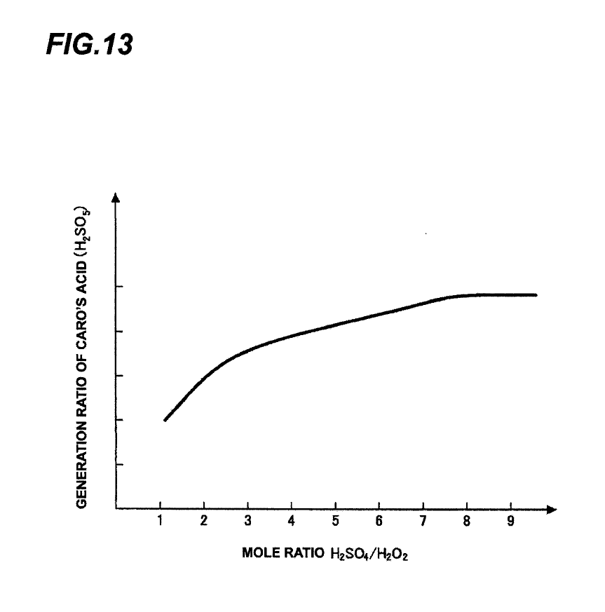

### DETAILED DESCRIPTION

In the following detailed description, reference is made to the accompanying drawings, which form a unit hereof. The illustrative embodiments described in the detailed description, drawings, and claims are not meant to be limiting. Other embodiments may be utilized, and other changes may be made, without departing from the spirit or scope of the subject matter presented here.

The present disclosure provides a substrate processing apparatus and a substrate processing method which can efficiently remove a resist residue on a substrate surface by using sulfuric acid, not by using hydrogen peroxide solution that is unstable in a high temperature. Further, the present disclosure provides a substrate processing apparatus and a substrate processing method which can efficiently remove a resist residue on a substrate surface by using sulfuric acid, even while using hydrogen peroxide solution that is unstable in a high temperature.

According to one embodiment, there is provided a substrate processing apparatus to process a substrate by using a first processing liquid including sulfuric acid and a second processing liquid including water. The substrate processing apparatus includes a liquid-film forming device to form a liquid film of the first processing liquid maintained at a temperature higher than room temperature on at least one surface of the substrate, and a vapor/mist supply device to supply vapor or mist of the second processing liquid to the surface of the substrate on which the liquid film of the first processing liquid is formed.

The liquid-film forming device may include a processing tank to store the first processing liquid at the temperature higher than room temperature, a processing chamber disposed above the processing tank to process the substrate by using the first processing liquid and the second processing liquid, and a substrate elevating mechanism to move the substrate up and down between the processing tank and the processing chamber. The vapor/mist supply device may supply vapor or mist of the second processing liquid to a portion of the substrate in the vicinity of the liquid surface of the first processing liquid stored in the processing tank when the substrate is lifted from or immersed into the processing tank by the substrate elevating mechanism.

In the present disclosure, the immersing of the substrate into the first processing liquid refers to not only moving the entire substrate below the liquid surface of the first processing liquid, but also moving a portion of the substrate below the liquid surface of the first processing liquid while another portion of the substrate is exposed above the liquid surface of the first processing liquid. Therefore, the immersing of the substrate into the first processing liquid also refers to moving a portion of the substrate down in a state where the portion of the substrate already has been below the liquid surface of the first processing liquid.

The substrate processing apparatus may further include an external tank to receive the first processing liquid overflowed from the processing tank, and a processing-liquid circulating device to collect the first processing liquid from the external tank and return the first processing liquid to the processing tank.

The vapor/mist supply device may be installed in the vicinity of the liquid surface of the first processing liquid stored in the processing tank within the processing chamber.

The substrate processing apparatus may further include an inert-gas supply device installed within the processing chamber to supply inert gas into the processing chamber.

The inert-gas supply device may be installed above the vapor/mist supply device.

The liquid-film forming device may include an arrangement board on which the substrate is laid, and a processing-liquid supply device to supply the first processing liquid maintained at the temperature higher than room temperature to the substrate laid on the arrangement board. The processing-liquid supply device may supply the first processing liquid onto the substrate laid on the arrangement board to form the liquid film of the first processing liquid maintained at the temperature higher than room temperature on the substrate.

The liquid-film forming device may include an arrangement board on which the substrate is laid to maintain the substrate at the temperature higher than room temperature, and a processing-liquid supply device to supply the first processing liquid to the substrate laid on the arrangement board. The processing-liquid supply device may supply the first processing liquid to the substrate laid on the arrangement board to form the liquid film of the first processing liquid maintained at the temperature higher than room temperature on the substrate.

According to another embodiment, there is provided a substrate processing method to process a substrate by using a first processing liquid including sulfuric acid and a second processing liquid including water. The substrate processing method includes forming a liquid film of the first processing liquid maintained at a temperature higher than room temperature on at least one surface of the substrate, and supply vapor or mist of the second processing liquid to the surface of the substrate on which the liquid film of the first processing liquid is formed.

Forming the liquid film may include immersing the substrate into or lifting the substrate from the first processing liquid maintained at the temperature higher than room temperature to form the liquid film of the first processing liquid maintained at the temperature higher than room temperature on the substrate. Supplying vapor or mist may include supply vapor or mist of the second processing liquid to a portion of the substrate in the vicinity of the liquid surface of the first processing liquid.

The substrate processing method may further include supplying inert gas to a processing chamber to hermetically process the substrate.

The inert gas may be supplied from an area above a vapor/mist supply device to supply vapor or mist of the second processing liquid.

Forming the liquid film may include apply the first processing liquid maintained at the temperature higher than room temperature on the substrate to form the liquid film of the first processing liquid maintained at the temperature higher than room temperature on the substrate.

Forming the liquid film may include applying the first processing liquid on the substrate maintained at the temperature higher than room temperature to form the liquid film of the first processing liquid maintained at the temperature higher than room temperature on the substrate.

According to still another embodiment, there is provided a substrate processing apparatus to process a substrate by using a first processing liquid including sulfuric acid and a second processing liquid including hydrogen peroxide solution. The substrate processing apparatus includes a processing tank to store the first processing liquid at a temperature higher than room temperature, a processing chamber disposed above the processing tank to process the substrate by using the first processing liquid and the second processing liquid, a substrate elevating mechanism to move the substrate up and down between the processing tank and the processing chamber, and a mist supply device to supply mist of the second processing liquid to a portion of the substrate in the vicinity of the liquid surface of the first processing liquid stored in the processing tank when the substrate is lifted from or immersed into the processing tank by the substrate elevating mechanism.

The substrate processing apparatus may further include an external tank to receive the first processing liquid overflowed from the processing tank, and a processing-liquid circulating device to collect the first processing liquid from the external tank and return the first processing liquid to the processing tank.

The mist supply device may be installed in the vicinity of the liquid surface of the first processing liquid stored in the processing tank within the processing chamber.

The substrate processing apparatus may further include an inert-gas supply device installed within the processing chamber to supply inert gas to the processing chamber.

The inert-gas supply device may be installed above the mist supply device.

According to yet still another embodiment, there is provided a substrate processing method to process a substrate by using a first processing liquid including sulfuric acid and a second processing liquid including hydrogen peroxide solution. The substrate processing method includes forming a liquid film of the first processing liquid maintained at a temperature higher than room temperature on the substrate by immersing the substrate into or lifting the substrate from the first processing liquid maintained at the temperature higher than room temperature, and supplying mist of the second processing liquid to a portion of the substrate in the vicinity of the liquid surface of the first processing liquid.

The substrate processing method may further include supplying inert gas into a processing chamber hermetically processing the substrate.

The inert gas may be supplied from an area above a mist supply device to supply mist of the second processing liquid.

According to the present disclosure, it is possible to efficiently remove the resist residue of the substrate surface by using sulfuric acid, not by using hydrogen peroxide solution that is unstable in a high temperature. Further, according to the present disclosure, it is possible to efficiently remove the resist residue of the substrate surface using sulfuric acid, even while using hydrogen peroxide solution that is unstable in a high temperature.

Hereinafter, embodiments of the present disclosure will be described with the accompanying drawings.

(First Embodiment)

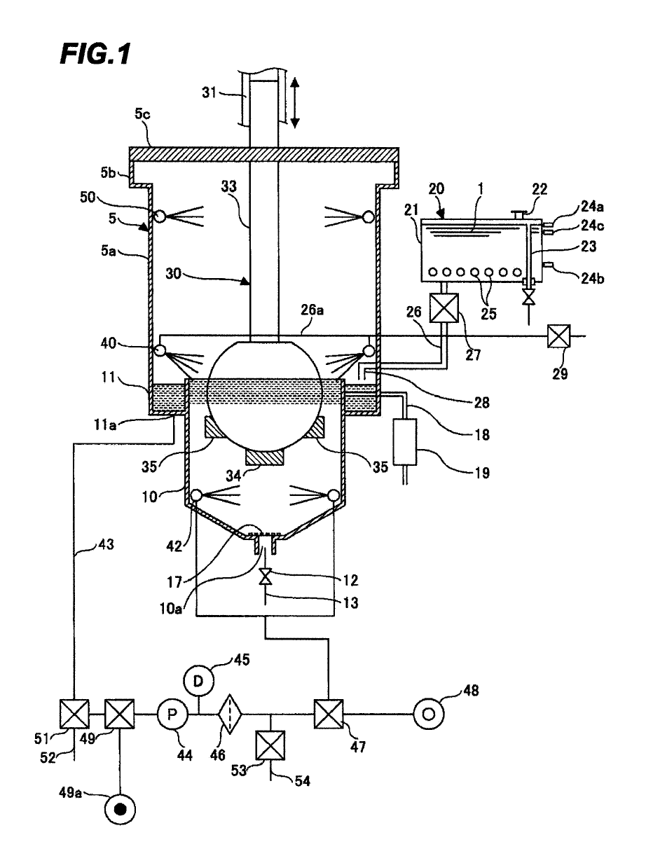

A substrate processing apparatus and a substrate processing method according to a first embodiment will be described with reference to FIGS. 1 to 6.

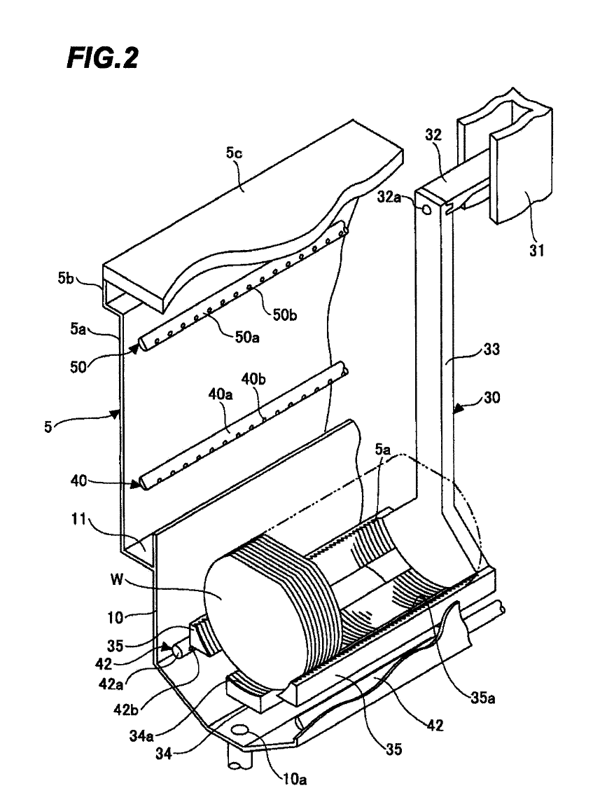

First, the substrate processing apparatus according to the first embodiment will be described with reference to FIGS. 1 and 2.

FIG. 1 is a cross-sectional view schematically illustrating the configuration of the substrate processing apparatus according to the present embodiment. FIG. 2 is a perspective view schematically illustrating the configuration of the substrate processing apparatus according to the present embodiment.

The substrate processing apparatus according to the present embodiment includes a processing chamber 5 to hermetically process a substrate by using a first processing liquid 1 including sulfuric acid and a second processing liquid, a processing tank 10 to store the first processing liquid in a higher temperature state than room temperature, an external tank 11 joining a top opening of processing tank 10 to receive first processing liquid 1 including sulfuric acid that is overflowed from processing tank 10, a wafer boat 30 serving as a support device to support a predetermined number (for example, fifty (50)) of semiconductor wafers (W) (hereinafter, referred to as “wafers”) serving as to-be-processed objects arranged at an appropriate distance from one another within processing tank 10, a first-processing-liquid receiving tank 20 to receive first processing liquid 1 quickly supplied into processing tank 10, a vapor/mist supply nozzle 40 serving as a vapor/mist supply device to supply the second processing liquid consisting of water in a state of vapor or mist to wafer W within processing tank 10, a supply nozzle 28 to supply first processing liquid 1 within first-processing-liquid receiving tank 20 into processing tank 10, and a jet nozzle 42 serving as a supply device disposed in a bottom part of processing tank 10 to supply first processing liquid 1 to wafer W.

Further, in the present embodiment, the example in which sulfuric acid is used as the first processing liquid and water is used as the second processing liquid is described. However, the first processing liquid is not specifically limited if the first processing liquid includes sulfuric acid. Further, the second processing liquid is not specifically limited if water is a main component in the second processing liquid. For example, the second processing liquid may include a surfactant.

Further, the vapor/mist supply nozzle according to embodiments and modifications thereof corresponds to the vapor/mist supply device in the present disclosure.

Processing chamber 5 is disposed above processing tank 10. Processing chamber 5 includes a sidewall 5a extending upwardly from a sidewall of external tank 11 opposite to a side of external tank 11 joining the top opening of processing tank 10, an opening 5b widening outwardly from an top opening of sidewall 5a to increase a cross-section area of an opening of processing chamber 5, and an upper cover 5c placed above opening 5b and hermetically engaged with opening 5b. A lower side of sidewall 5a of processing chamber 5 is integrally connected with the sidewall of external tank 11 opposite to the side of external tank 11 joining the top opening of processing tank 10.

Processing chamber 5, processing tank 10, and external tank 11 are made of a material having sufficient corrosion resistance and chemical resistance (for example, quartz). A discharge port 10a is formed at the bottom of processing tank 10 and a drain pipe 13 is connected to discharge port 10a through a drain valve 12. A mesh 17 is provided on an upper part of discharge port 10a, and dust in the chemical liquid discharged from processing tank 10 can be collected by mesh 17. Further, a first-processing-liquid ejection pipe 18 is connected to the upper part of processing tank 10, for example, a location separated from the upper end of processing tank 10 with a distance of 20 mm to 40 mm. A specific resistance value of first processing liquid 1 within processing tank 10 is measured by a specific-resistance detector 19 connected to first-processing-liquid ejection pipe 18.

A discharge port 11a is formed at the bottom of external tank 11, and discharge port 11a is connected with jet nozzle 42 and a circulation pipeline 43. A pump 44, a damper 45, and a filter 46 are provided at circulation pipeline 43 from discharge port 11a in sequence. A deionized-water source 48 is connected between filter 46 and jet nozzle 42 through a switch valve 47. Further, a drain pipe 52 is connected between discharge port 11a and pump 44 through a switch valve 51, and a first-processing-liquid source 49a is connected between discharge port 11a and pump 44 through a switch valve 49. A drain pipe 54 is branched between filter 46 and switch valve 47 through a drain valve 53. Circulation pipeline 43, pump 44, damper 45, and filter 46 correspond to a processing-liquid circulating device in the present disclosure.

As shown in FIG. 2, jet nozzle 42 includes a plurality of nozzle holes 42b arranged at an appropriate distance from one another in a longitudinal direction of pipe-shaped nozzle bodies 42a. Nozzle bodies 42a are disposed in both sides below wafer W held by wafer boat 30.

As described above, by installing a circulation piping system between jet nozzle 42 and discharge port 11a of external tank 11, if the first processing liquid supplied from first-processing-liquid source 49a into processing tank 10 through pump 44 is overflowed from processing tank 10, external tank 11 receives the overflowed first processing liquid. The first processing liquid is withdrawn from external tank 11 and the withdrawn first processing liquid is recycled for reuse. The recycled first processing liquid is circulated in circulation pipeline 43 to repeatedly supply the circulated first processing liquid from jet nozzle 42 to wafer W and remove particles, metal ions, or an oxidation film attached to the surface of wafer W. Further, after the first processing liquid is discharged, switch valve 47 is switched to inject deionized water, which is supplied from deionized-water source 48, from jet nozzle 42 to wafer W and remove the chemical liquid attached to wafer W. In this case, deionized water overflowed from processing tank 10 is discharged through drain pipe 52.

As shown in FIG. 1, first-processing-liquid tank 20 includes an air introducing port 22 to supply first processing liquid 1 to processing tank 10. Air introducing port 22 is provided on an upper end of a hermetic tank body 21 of first-processing-liquid tank 20. Further, an overflow pipe 23 is disposed within tank body 21 to uniformly maintain an amount of first processing liquid 1 within tank 20. An upper limit sensor 24a, a lower limit sensor 24b, and a proper amount sensor 24c are arranged near an outside of tank body 21 to detect an upper limit, a lower limit, and a proper amount of the liquid level of first processing liquid 1, respectively. A predetermined amount of first processing liquid 1 is always held in the tank by means of those sensors. In this case, the volume of first processing liquid 1 in the tank is at least the volume quickly supplied to processing tank 10 one time, for example, 35 l or more. The volume of first processing liquid 1 in the tank may be the volume of first processing liquid 1 quickly supplied to processing tank 10 two times, for example, 70 . Further, a heater 25 including a quartz pipe and a heater line inserted through the quartz pipe is placed at the bottom of tank body 21 to heat first processing liquid 1 within the tank to a predetermined temperature, for example, between 150° and 170°.

A supply port (not shown) formed at the bottom of tank body 21 of first-processing-liquid receiving tank 20 is connected with supply nozzle 28 through a supply pipe 26. First processing liquid 1 within first-processing-liquid receiving tank 20 is supplied from supply nozzle 28 into processing tank 10 through opening/closing a supply valve 27 installed at supply pipe 26.

Vapor/mist supply nozzles 40 are connected to a deionized-water supply pipe 26a of a factory having an opening/closing valve 29. Vapor/mist supply nozzles 40 are disposed at an upper part of both facing lateral sides of processing tank 10 as shown in FIGS. 1 and 2. Each vapor/mist supply nozzle 40 includes a plurality of vapor/mist supply nozzle holes 40b formed at an appropriate distance from one another in the lower part of a pipe-shaped nozzle body 40a.

As shown in FIG. 2, wafer boat 30 includes a pair of support members 33 shaped like a reverse T (one piece is shown in the drawing). Support member 33 is fixed to an attachment member 32 by a bolt 32a. Attachment member 32 is connected to a substrate elevating mechanism 31 disposed in an outside of processing tank 10. Wafer boat 30 also includes a center support rod 34 installed at a central lower part between support members 33, and two lateral support rods 35 installed in parallel at both of right and left ends between support members 33. Wafer boat 30 moves up and down within processing chamber 5 by the driving of substrate elevating mechanism 31 and moves the substrate up and down between processing tank 10 and processing chamber 5. Further, when lifting the substrate from processing tank 10 or immersing the substrate into processing tank 10 by substrate elevating mechanism 31 as described below, vapor/mist supply nozzle 40 supplies vapor or mist of the second processing liquid to a portion of the substrate in the vicinity of the liquid surface of the first processing liquid stored in processing tank 10. A plurality of, for example, fifty (50), support grooves 34a and 35a are provided in center support rod 34 and lateral support rods 35 at an appropriate distance from one another in a longitudinal direction, respectively. Those support rods 34 and 35 are made of a material having excellent corrosion resistance, heat resistance, and strength resistance, for example, polyetheretherketone (PEEK) or quartz.

An inert-gas supply nozzle 50 is provided above vapor/mist supply nozzle 40 in processing chamber 5. Inert-gas supply nozzle 50 supplies inert gas including nitrogen gas into processing chamber 5. Like vapor/mist supply nozzle 40, inert-gas supply nozzle 50 includes a plurality of inert-gas supply nozzle holes 50b formed at an appropriate distance from one another in the lower part of a pipe-shaped nozzle body 50a within the processing tank. Inert-gas supply nozzle 50 corresponds to an inert-gas supply device of the present disclosure.

Further, a reactive gas generated through the reaction of a liquid film of high-temperature sulfuric acid with water is sealed within processing chamber 5 hermetically installed, and the reactive gas is exhausted through an exhaustion pipe (not shown).

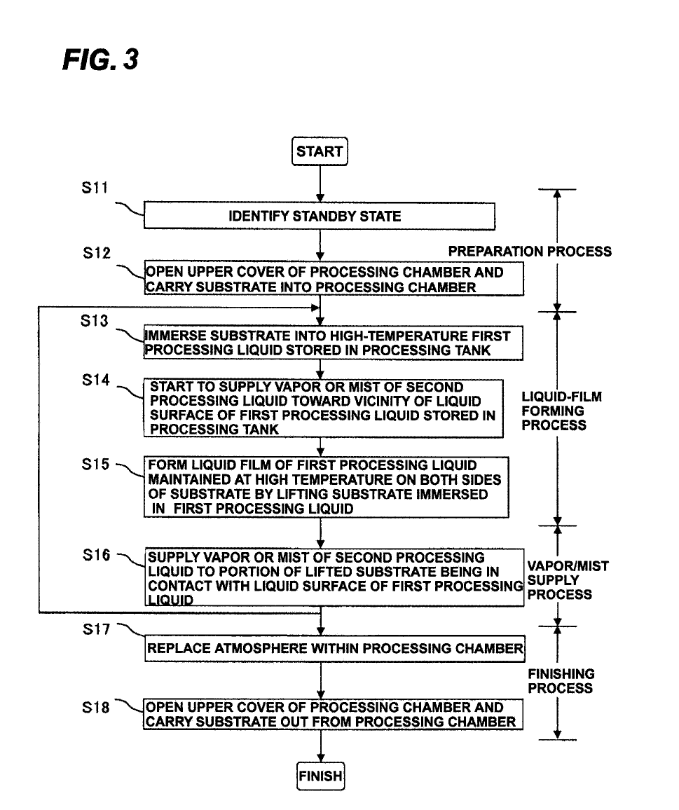

Next, the substrate processing method using the substrate processing apparatus according to the present embodiment will be described with reference to FIGS. 3 to 5.

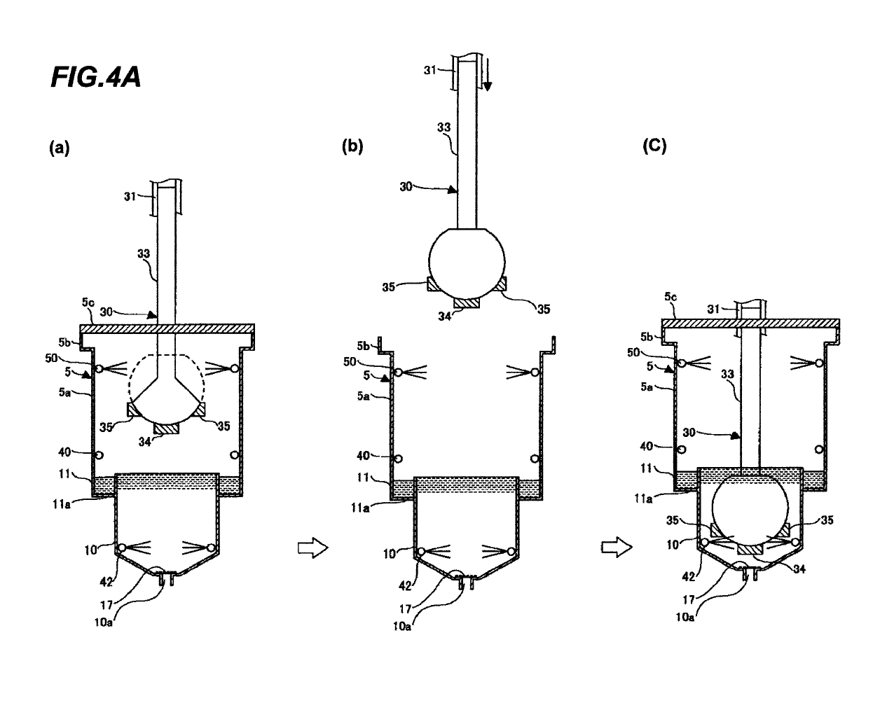

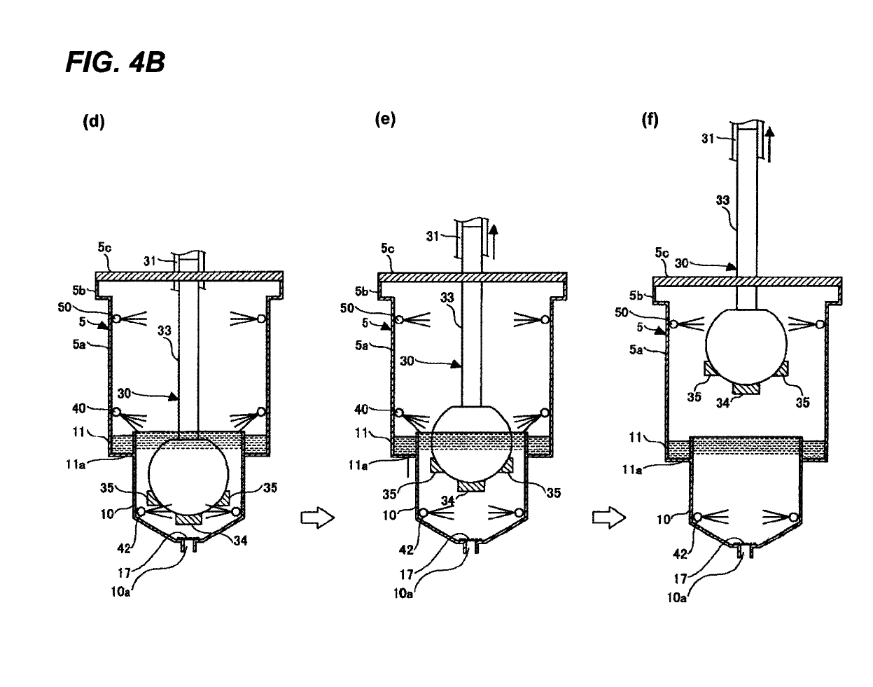

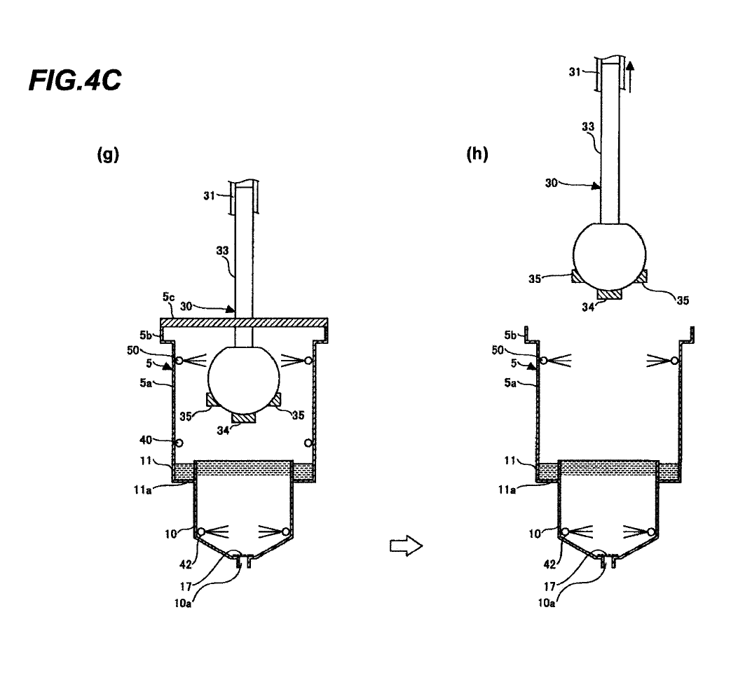

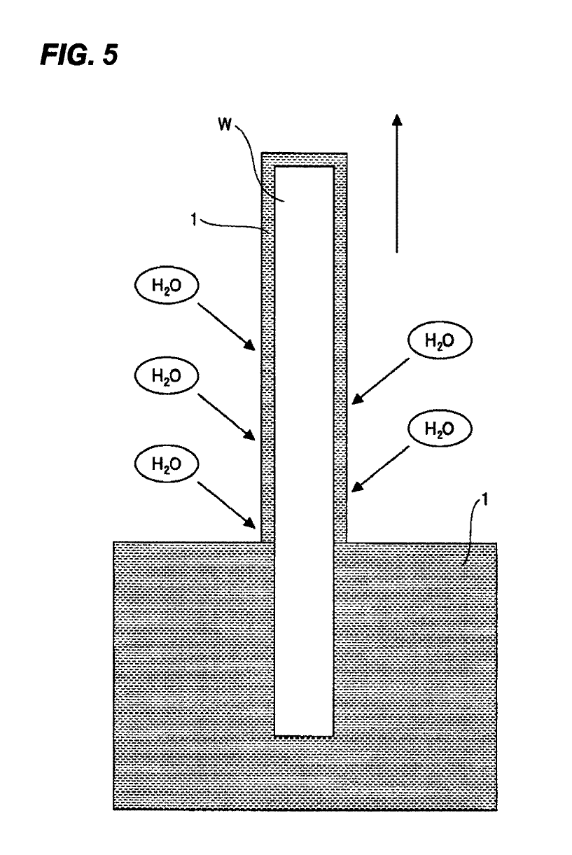

FIG. 3 is a flowchart illustrating a sequence of each process of the substrate processing method according to the present embodiment. FIGS. 4A to 4C are cross-sectional views schematically illustrating an inside of the processing chamber in each process of the substrate processing method according to the present embodiment. The views of the inside of the processing chamber during or after performing each of steps S11 to S18 of FIG. 3 correspond to the schematic cross-sectional views of FIGS. 4A (a) to 4C (h), respectively. FIG. 5 is a view schematically illustrating the supply of vapor or mist of the second processing liquid to a portion of the lifted substrate in the vicinity of the liquid surface of the first cleaning liquid stored in the processing tank in the substrate processing method according to the present embodiment.

As shown in FIG. 3, the substrate processing method according to the present embodiment includes a preparation process, a liquid-film forming process, a vapor/mist supply process, and a finishing process. The preparation process includes steps S11 and S12, the liquid-film forming process includes steps S13 to S15, the vapor/mist supply process includes step S16, and the finishing process includes steps S17 and S18.

At first, the preparation process including steps S11 and S12 is performed.

First, step S11 is performed. Step S11 is a step to prepare before loading the wafer into the processing chamber. FIG. 4A (a) is a cross-sectional view schematically illustrating the inside of the processing chamber when step S11 is performed.

In step S11, as shown in FIG. 4A (a), wafer boat 30 is accommodated in processing chamber 5 without supporting wafer W. First processing liquid 1 including sulfuric-acid cleaning liquid maintained at a high temperature is supplied to processing tank 10. Inert gas is supplied from inert-gas supply nozzle 50.

In particular, first processing liquid 1 is overflowed from processing tank 10 and overflowed first processing liquid 1 is injected from jet nozzle 42 into processing tank 10 through the driving of pump 44 of circulation pipeline 43.

Next, step S12 is performed. Step S12 is a step to open the upper cover of the processing chamber and support the wafer on the wafer boat. FIG. 4A (b) is a cross-sectional view schematically illustrating the inside of the processing chamber when step S12 is performed.

The supply of the inert gas from the inert-gas supply nozzle is stopped and upper cover 5c of processing chamber 5 is opened. Wafer boat 30 is lifted by substrate elevating mechanism 31 to receive a plurality of, for example, fifty (50), wafers W carried by a wafer chuck (not shown). Wafer boat 30 is lowered into processing chamber 5 again. Upper cover 5c of processing chamber 5 is closed and sealed.

Next, the liquid-film forming process including steps S13 to S15 and the vapor mist supply process including step S16 are performed.

First, step S13 is performed. Step S13 is a step to immerse the substrate into the first processing liquid including sulfuric acid maintained at a high temperature. FIG. 4A (c) is a cross-sectional view schematically illustrating the inside of the processing chamber when step S13 is performed.

The substrate (wafer W) is immersed into processing chamber 10 and it waits until the temperature of the substrate increases up to the same temperature of first processing liquid 1 including sulfuric acid maintained at a high temperature. For example, it waits for about 20 seconds.

Simultaneously, nitrogen gas is supplied from inert-gas supply nozzle 50. The nitrogen gas functions as buffer gas for controlling an atmosphere and controlling gas distribution of vapor to be supplied to a portion of the substrate being in contact with or in the vicinity of the liquid surface of the cleaning liquid. The nitrogen gas also functions as a replacing gas for replacing gas within processing chamber 5 in the finishing process as described later. The nitrogen gas prevents vapor or mist including sulfuric acid generated when supplying vapor or mist of water to sulfuric acid included in the liquid film formed on the surface of the substrate (wafer) or sulfuric acid stored in processing tank 10 from being diffused within processing chamber 5. The nitrogen gas replaces an atmosphere including sulfuric acid within processing chamber 5 with the inert gas atmosphere when the substrate (wafer) is ejected from processing chamber 5, or prevents the atmosphere including sulfuric acid within processing chamber 5 from leaking out of processing chamber 5.

Nitrogen gas corresponds to inert gas in the present disclosure. However, inert gas in the present disclosure includes He, Ar, and Xe, and not limited thereto.

Next, step S14 is performed. Step S14 is a step to start supplying vapor or mist of the second processing liquid consisting of water toward the vicinity of the liquid surface of a sulfuric-acid cleaning liquid. FIG. 4B (d) is a cross-sectional view schematically illustrating the inside of the processing chamber after step S14 is performed.

The second processing liquid can be supplied in any one form of vapor, mist, or a mixture thereof. Hereinafter, the supply of the second processing liquid in the vapor state will be described in the present embodiment and the supply of the second processing liquid in the mist state will be described in the modification of the first embodiment.

Opening/closing valve 29 is opened and deionized water supplied from deionized-water supply pipe 26a of the factory is supplied in the state of vapor from vapor/mist supply nozzle 40 to wafer W. Deionized water may be supplied in the state of vapor through a vapor generator (not shown) installed on the route or in the state of vapor of which the temperature is controlled through a temperature controller (not shown) installed on the route. Further, as described later, the temperature of vapor may be a temperature allowing the temperature of the liquid film of the first processing liquid including sulfuric acid formed on the surface of the substrate not to decrease below the predetermined temperature. For example, the temperature of vapor may be 100° or higher, in particularly 110° or higher, but is not limited thereto.

Next, steps S15 and S16 are simultaneously performed. Step S15 is a step to form the liquid film of the sulfuric-acid cleaning liquid maintained at the high temperature on both sides of the substrate through lifting the substrate that has been immersed into the sulfuric-acid cleaning liquid maintained at the high temperature. Step S16 is a step to supply vapor to a portion of the lifted substrate being in contact with or in the vicinity of the liquid surface of the sulfuric-acid cleaning liquid. FIGS. 4B (e) and 4B (f) are the cross-sectional views schematically illustrating the inside of the processing chamber during and after the simultaneous performance of steps S15 and S16, respectively.

In particular, through upwardly lifting wafer boat 30 slowly by using substrate elevating mechanism 31, the substrate is lifted from the sulfuric-acid cleaning liquid in the state where the liquid film of the sulfuric-acid cleaning liquid maintained at a high temperature is formed on both sides of the substrate. Vapor is supplied to the vicinity of a portion of the lifted substrate being in contact with the liquid surface of the sulfuric-acid cleaning liquid, i.e. the interface between the sulfuric-acid cleaning liquid and the substrate.

If a supply rate of vapor supplied from a shower supply nozzle is a predetermined value, the rate of lifting the substrate may be a rate allowing the temperature of the substrate to be almost the same as the temperature of the processing liquid stored in the processing tank. For example, the rate of lifting the substrate may be between 10 mm/sec and 50 mm/sec, but is not limited thereto.

Here, an operational effect of removing the resist residue of the substrate surface when vapor or mist of water is supplied toward the liquid surface of the sulfuric-acid cleaning liquid, i.e. the vicinity of the interface between the sulfuric-acid cleaning liquid and the substrate will be described with reference to FIG. 5.

Referring to FIG. 5, the liquid film is formed on both sides of wafer W lifted from the sulfuric-acid cleaning liquid. Wafer W is slowly lifted from the sulfuric-acid cleaning liquid maintained at the high temperature and a portion of wafer W higher than the liquid surface of the sulfuric-acid cleaning liquid is not maintained at the high temperature. Thus, the temperature of lifted wafer W is the same as the temperature of the sulfuric-acid cleaning liquid at the portion of wafer W being in contact with the liquid surface of the sulfuric-acid cleaning liquid. However, the temperature of the portion of wafer W decreases than that of the sulfuric-acid cleaning liquid as a distance of a portion of wafer W upwardly from the liquid surface increases.

If vapor is supplied toward the vicinity of the liquid surface of the sulfuric-acid cleaning liquid when the substrate with the liquid film that has the temperature distribution in an up and down direction as described above is lifted from the sulfuric-acid cleaning liquid, the portion of the substrate being in contact with the liquid surface or in the vicinity of the liquid surface of the sulfuric-acid cleaning liquid is maintained at the high temperature, and thus sulfuric acid of the liquid film, which is formed on the surface of the substrate and maintained at the high temperature, reacts with high-temperature vapor generated by the temperature increase of the supplied vapor on the surface of the high-temperature substrate. For example, if a small amount of oxygen is contained in high-temperature vapor, the oxygen dissociates to generate active oxygen, or high-temperature vapor itself dissociates to generate active oxygen. The active oxygen generated as described above reacts with sulfuric acid, and the chemical reaction represented by Formula (4) occurs to generate Caro's acid.

H₂SO₄+O*→H₂SO₅ Formula (4)

Herein, in order to promote the chemical reaction of Formula (4), the temperature of the liquid film may be maintained as high as possible for increasing the reaction rate and water may be supplied in the state of vapor as far as possible for increasing an area of the interface in which the reaction occurs. Therefore, if water is supplied in the form of vapor, water may be dissolved in sulfuric acid forming the liquid film in the state of vapor without condensing in the vicinity of the liquid film. The temperature of the liquid film may be 100° or higher that is the boiling point of water. For example, the temperature of the liquid film is 110° because vapor is almost not dissolved in sulfuric acid forming the liquid film and Caro's acid is efficiently generated since the amount of vapor dissolved in sulfuric acid is small, sulfuric acid in the processing chamber is not diluted, and a heat-resistance processing of each component of the substrate processing apparatus is relatively easy. As a result, it may not need to use hydrogen peroxide solution as the second processing liquid since sulfuric acid of the temperature higher than room temperature reacts with active oxygen in the surface of the substrate to generate Caro's acid. Also, the reaction rate can be greater and stronger reaction can occur in the aforementioned interface since it is possible to use the temperature higher than room temperature. Therefore, using the above reaction, the substrate processing of efficiently removing the resist residue of the substrate surface can be performed.

Here, the supply rate of vapor may be a rate allowing an amount of vapor to be enough for generating Caro's acid sufficiently and not cooling the liquid film of sulfuric acid. For example, the supply rate of vapor may be 1 cc/sec, but is not limited thereto. Further, since the temperature of the sulfuric-acid cleaning liquid is high, there is no remaining water in processing tank 10.

Further, in the present embodiment, because the substrate is continuously lifted in the state where vapor is continuously supplied, step S15 of the liquid-film forming process and step S16 of the vapor/mist supply process are continuously performed at the same time. However, steps S15 and S16 can be performed in sequence if the supply of vapor is stopped, the lift of the substrate from the sulfuric-acid cleaning liquid is stopped on the way, vapor is re-supplied toward the vicinity of the liquid surface of the sulfuric-acid cleaning liquid in that state, the supply of vapor is stopped, the substrate is lifted from the sulfuric-acid cleaning liquid again, and then these are repeated during step S15.

After performing steps S15 and S16, a cycle of lowering the substrate again to immerse the substrate into the sulfuric-acid cleaning liquid and performing steps S15 and S16 again can be repeated in several times as necessary. Through such a repetition, the resist residue of the substrate surface can be more clearly removed. The rate of lowering the substrate may be, for example, 150 mm/sec.

Next, the finishing process including steps S17 and S18 is performed.

First, step S17 is performed. Step S17 is a step to replace the atmosphere within the processing chamber. FIG. 4C (g) is a cross-sectional view schematically illustrating the inside of the processing chamber when step S17 is performed.

Opening/closing valve 29 is closed and the supply of vapor from vapor/mist supply nozzle 40 is stopped. At this time, the supply of the sulfuric-acid cleaning liquid from jet nozzle 42 may be stopped, or the sulfuric-acid cleaning liquid from jet nozzle 42 may be supplied continuously as shown in FIG. 4C (g).

At this time, the inert-gas supply nozzle is continuously opened to replace the inside of the processing chamber with gas for a period (for example, about 30 seconds). This is for making the atmosphere within the processing chamber inactive in order to subsequently open the upper cover of the processing chamber and stopping the reaction of sulfuric acid and vapor. Various inert gases including He, Ar, or Xe may be used instead of nitrogen gas heated to room temperature or higher.

Finally, step S18 is performed. Step S18 is a step to carry the substrate out from the processing chamber. FIG. 4C (h) is a cross-sectional view schematically illustrating the inside of the processing chamber when step S18 is performed.

A supply valve (not shown) is closed to stop the supply of inert gas. Upper cover 5c of processing chamber 5 is opened and wafer boat 30 is lifted by substrate elevating mechanism 31 to carry out wafer W from processing chamber 5. Wafer W is clamped by a wafer chuck (not shown) to be ejected to the outside.

According to the present embodiment, since high-temperature sulfuric acid of the substrate surface reacts with active oxygen to generate Caro's acid, the substrate processing of efficiently removing the resist residue of the substrate surface can be performed without using hydrogen peroxide solution that is easily dissolved in the high temperature.

That is, through making only the liquid of the interface have a high reactivity, and not making the liquid of the circulation line have a high reactivity, the temperature of the circulated sulfuric acid can be higher in comparison with the temperature in accordance with mixing hydrogen peroxide solution with sulfuric acid. Therefore, the cleaning effect can be improved. Further, since the temperature of sulfuric acid is high, an added solution is not necessarily to be hydrogen peroxide solution, and may be deionized water. Therefore, the operation cost is saved.

Further, in the present embodiment, the substrate is immersed into the first processing liquid in step S13, the liquid film of the first processing liquid maintained at the temperature higher than room temperature is formed on the substrate through lifting the substrate in step S15, and vapor of the second processing liquid is supplied to a portion of the lifted substrate being in contact with the liquid surface or in the vicinity of the liquid surface of the first processing liquid in step S16. However, the liquid film of the first processing liquid maintained at the temperature higher than room temperature may be formed on the substrate by lowering and immersing the substrate into the first processing liquid, and vapor of the second processing liquid may be supplied to a portion of the lowered substrate being in contact with the liquid surface or in the vicinity of the liquid surface of the first processing liquid. In this case, step S13 is a step to lift the substrate from the high-temperature first processing liquid stored in the processing tank or maintain the state of the lifted substrate as it is. Also, step S15 is a step to form the liquid film of the first processing liquid maintained at the high temperature on the substrate through immersing (lowering) the substrate into the first processing liquid, and step S16 is a step to supply vapor of the second processing liquid to a portion of the immersed (lowered) substrate being in contact with the liquid surface or in the vicinity of the liquid surface of the first processing liquid.

(Modification of the First Embodiment)

Next, the substrate processing apparatus and the substrate processing method according to the modification of the first embodiment will be described.

The substrate processing method according to the present modification is characterized in using mist of water, instead of vapor, in the substrate processing apparatus and the substrate processing method according to the first embodiment.

That is, in the present modification, the temperature of the water supplied from vapor/mist supply nozzle 40 is 100° or lower and the second processing liquid supplied from vapor/mist supply nozzle 40 is supplied in the state of mist of water, not vapor. At this time, the temperature of the mist may be a temperature allowing the temperature of the liquid film of the first processing liquid including sulfuric acid formed on the substrate surface not to decrease below the predetermined temperature.

In the present modification, mist of water, not vapor, is supplied to the portion of the substrate being in contact with the liquid surface or in the vicinity of the liquid surface of the first processing liquid including sulfuric acid during step S16 shown in FIG. 3. Therefore, in comparison with the first embodiment, the temperature of the liquid film including sulfuric acid is lower than that of sulfuric acid within processing tank 10 in the portion of the substrate to which mist of water is supplied. However, through setting the temperature of sulfuric acid of processing tank 10 to be higher and controlling the rate of lifting the substrate from sulfuric acid and the rate of supplying mist of water, the temperature of the portion of the substrate being in contact with the liquid surface or in the vicinity of the liquid surface of sulfuric acid can be also maintained at a high temperature. Further, it can make the temperature of vapor/mist supply nozzle 40 and deionized-water supply pipe 26a to be lower, so that the producing cost can be saved.

Even in the present modification, when mist of water is supplied toward the vicinity of the liquid surface of the sulfuric-acid cleaning liquid, the operational effect of removing the resist residue of the substrate surface is similar to that of the first embodiment.

That is, in order to promote the chemical reaction of aforementioned Formula (4), the temperature may be maintained as high as possible for increasing the reaction rate and mist of water with a diameter of its droplet as small as possible may be supplied for increasing an area of the interface in which the reaction occurs. Therefore, if water is supplied in the state of mist, water may be evaporated in the vicinity of the liquid film to be dissolved in sulfuric acid forming the liquid film in the state of vapor. For example, the temperature of the liquid film may be 100° of the boiling point or higher. Also, the temperature of the liquid film may be the high temperature of 110° or higher since the amount of vapor dissolved in sulfuric acid is small, vapor is almost not dissolved in sulfuric acid forming the liquid film, Caro's acid is efficiently generated, and sulfuric acid in the processing chamber is not diluted. The temperature of the liquid film may be the high temperature of 130° or higher. Because the reaction rate significantly increases in this temperature range although the reaction rate of the chemical reaction represented by Formula (4) increases up to 322° that is the boiling point of sulfuric acid. As a result, in the present modification, sulfuric acid at the high temperature, for example, 130° or higher reacts with active oxygen on the surface of the substrate to generate Caro's acid, so that it may not need to use hydrogen peroxide solution as the second processing liquid. Also, the high temperature of 130° or higher can be utilized, so that the reaction rate is great and it is possible to perform the substrate processing for efficiently removing the resist residue of the substrate surface.

In the present modification, the substrate is immersed into the first processing liquid in step S13, the liquid film of the first processing liquid maintained at the temperature higher than room temperature is formed on the substrate through lifting the substrate in step S15, and mist of the second processing liquid is supplied to the portion of the lifted substrate being in contact with the liquid surface or in the vicinity of the liquid surface of the first processing liquid in step S16. However, by means of lowering and immersing the substrate into the first processing liquid, the liquid film of the first processing liquid maintained at the temperature higher than room temperature may be formed on the substrate and mist of the second processing liquid may be supplied to the portion of the lowered substrate being in contact with the liquid surface or in the vicinity of the liquid surface of the first processing liquid. In this case, step S13 is a step to lift the substrate from the high-temperature first processing liquid stored in the processing tank or maintain the state of the lifted substrate as it is. Step S15 is a step to form the liquid film of the first processing liquid maintained at the temperature on the substrate through immersing (lowering) the substrate into the first processing liquid. Step S16 is a step to supply mist of the second processing liquid to the portion of the immersed (lowered) substrate being in contact with the liquid surface or in the vicinity of the liquid surface of the first processing liquid.

(Second Embodiment)

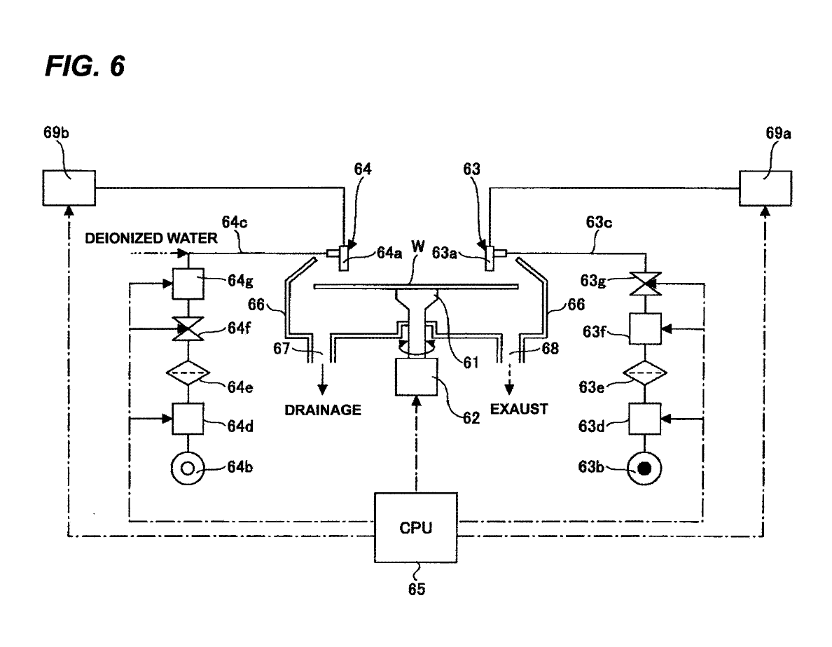

Next, the substrate processing apparatus and the substrate processing method according to the second embodiment will be described with reference to FIGS. 6 to 9.

First, the substrate processing apparatus according to the present embodiment will be described with reference to FIG. 6. FIG. 6 is a configuration view schematically illustrating the substrate processing apparatus according to the present embodiment.

The substrate processing apparatus according to the present embodiment includes a spin chuck 61 serving as an arrangement board on which a semiconductor wafer W, which is a to-be-processed substrate, (hereinafter, referred to as “wafer W”) is rotatably laid, a motor 62 serving as a rotation driving device to rotate spin chuck 61, a processing-liquid supply device 63 to supply the first processing liquid including sulfuric acid to the surface of wafer W supported by spin chuck 61, vapor/mist supply device 64 to supply the second processing liquid consisting of water to the surface of wafer W supported by spin chuck 61 in the state of vapor or mist, and a control device 65 to control at least the timing of supplying the processing liquid and removing the processing liquid.

A cup 66 is disposed in the vicinity or a lower part of spin chuck 61 and wafer W supported by spin chuck 61. Cup 66 prevents the first processing liquid or the second processing liquid from scattering to the outside. Further, a liquid discharge port 67 and a gas exhaust port 68 are provided at the bottom of cup 66.

Further, even in the present embodiment, the example in which sulfuric acid is used as the first processing liquid and water is used as the second processing liquid is described. However, if the first processing liquid includes sulfuric acid, the first processing liquid is not specifically limited. If water is a main component in the second processing liquid, the second processing liquid may include a surfactant and the second processing liquid is not specifically limited.

Processing-liquid supply device 63 is configured to be horizontally movable above wafer W and vertically movable to approach near to the surface of wafer W by a moving mechanism 69a. Processing-liquid supply device 63 includes a processing-liquid supply nozzle 63a to supply (discharge) the first processing liquid including sulfuric acid onto the upper surface of wafer W. A processing-liquid supply pipeline 63c connects processing-liquid supply nozzle 63a with a processing-liquid source 63b. A processing-liquid supply pump 63d, a filter 63e, a temperature controller 63f to control the temperature of the first processing liquid into a predetermined temperature, and an opening/closing valve 63g are sequentially installed at processing-liquid supply pipeline 63c from a side of processing-liquid source 63b.

Further, vapor/mist supply device 64 is configured to be movable vertically and horizontally above wafer W by a moving mechanism 69b. Vapor/mist supply device 64 includes a vapor/mist supply nozzle 64a to supply (discharge or inject) the second processing liquid consisting of water in the state of vapor or mist to the upper surface of wafer W. A vapor/mist supply pipeline 64c connects vapor/mist supply nozzle 64a with a vapor/mist source 64b. A flow rate controller 64d, a filter 64e, an opening/closing valve 64f, and a temperature controller 64g to control the temperature of the vapor or mist of the second processing liquid into a predetermined temperature are sequentially installed at vapor/mist supply pipeline 64c from a side of processing-liquid source 64b. Further, a source (not shown) of rinsing liquid such as deionized water is connected between temperature controller 64g and vapor/mist supply nozzle 64a of vapor/mist supply pipeline 64c through a switch valve (not shown).

Control device 65 may be configured with a central processing unit (CPU). A control signal from control device 65 (hereinafter, referred to as “CPU 65”) is transmitted to motor 62, a driving system including moving mechanism 69a of processing-liquid supply nozzle 63a and moving mechanism 69b of vapor/mist supply nozzle 64a, processing-liquid supply pump 63d, temperature controller 63f, and opening/closing valve 63g of processing-liquid supply device 63, and flow rate controller 64d, opening/closing valve 64f, and temperature controller 64g of vapor/mist supply device 64.

Therefore, the number of revolutions of motor 62 can be converted into a predetermined number of revolutions, for example, a low-speed rotation of between 1 rpm and 150 rpm, a mid-speed rotation of between 100 rpm and 500 rpm, and a high-speed rotation of between 500 rpm and 3000 rpm by the control signal from CPU 65. In this case, the low-speed rotation refers to the rotation allowing the first processing liquid not to spread as the liquid film by the centrifugal force even if the first processing liquid is supplied to the surface of wafer W. The mid-speed rotation refers to the rotation allowing the first processing liquid supplied to the surface of wafer W to spread by the centrifugal force and form the liquid film. The high-speed rotation refers to the rotation allowing the liquid film formed on the surface of wafer W to be shaken off by the centrifugal force.

Further, spin chuck (arrangement board) 61 and processing-liquid supply device 63 of the present embodiment correspond to a liquid-film forming device of the present disclosure. For example, spin chuck 61 can function as a liquid-film forming device at the mid-speed rotation.

Further, processing-liquid supply nozzle 63a or vapor/mist supply nozzle 64a is configured to move horizontally and vertically above wafer W, i.e. relatively to wafer W, by the control signal from CPU 65. Further, a predetermined amount of vapor or mist of the first processing liquid or second processing liquid is supplied to wafer W by the control signal from CPU 65.

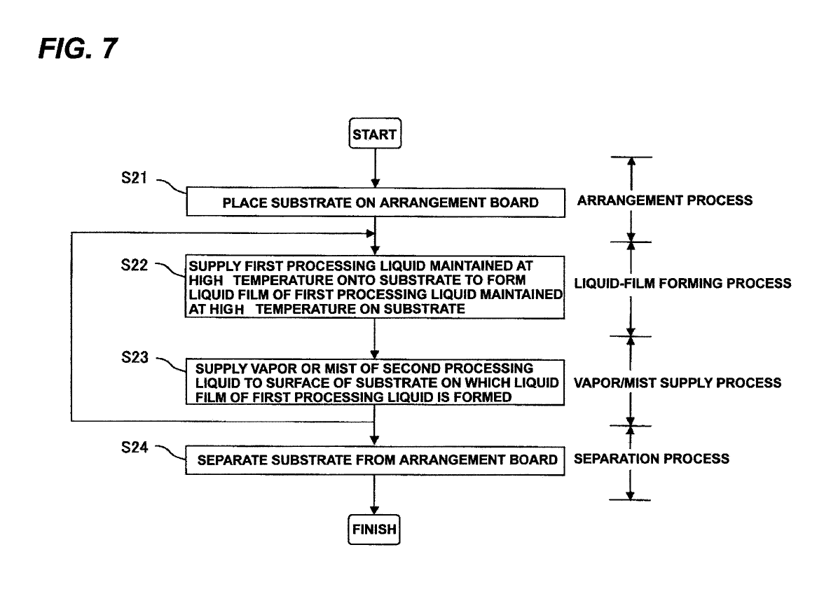

Next, the substrate processing method according to the present embodiment will be described with reference to FIGS. 7 to 9.

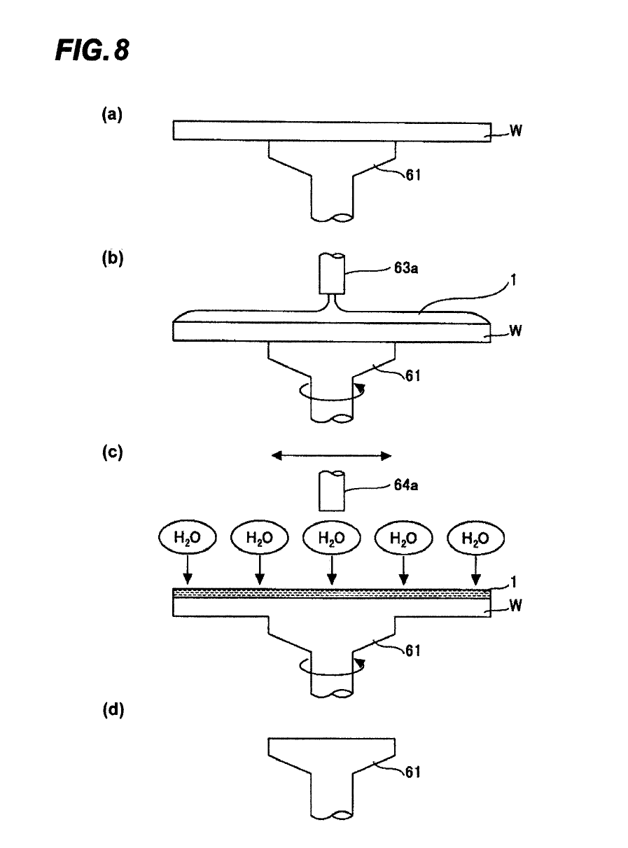

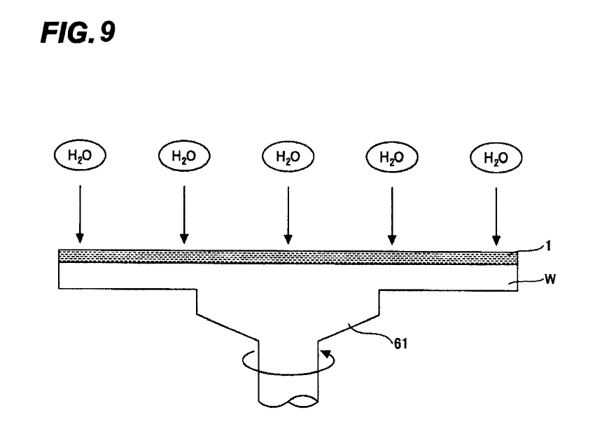

FIG. 7 is a flowchart illustrating a sequence of each process of the substrate processing method according to the present embodiment. FIG. 8 is a cross-sectional view schematically illustrating an inside of the cup in each process in the substrate processing method according to the present embodiment. The views of the inside of the cup during or after the performance of steps S21 to S24 of FIG. 7 correspond to the schematic cross-sectional views of FIGS. 8A to 8D, respectively. FIG. 9 is a view schematically illustrating the supply of vapor/mist of the second processing liquid to the surface of the substrate on which the liquid film of the first processing liquid is formed in the substrate processing method according to the present embodiment.

The substrate processing method according to the present embodiment, as shown in FIG. 7, includes an arrangement process, a liquid-film forming process, a vapor/mist supply process, and a separation process. The arrangement process includes step S21, the liquid-film forming process includes step S22, the vapor/mist supply process includes step S23, and the separation process includes step S24.

First, the arrangement process including step S21 is performed. Step S21 is a step to place the substrate on the spin chuck that is the arrangement board. FIG. 8A is a cross-sectional view schematically illustrating the inside of the cup after step S21 is performed.

Wafer W is carried onto spin chuck 61 by a carrying device (not shown) and is laid and supported on spin chuck 61. Then, processing-liquid supply nozzle 63a moves to above a central part of wafer W by driving moving mechanism 69a. In this state, spin chuck 61 and wafer W rotates at a low-speed rotation, for example, the number of revolutions of 35 rpm by driving motor 2. First processing liquid 1 including a predetermined amount of sulfuric acid is discharged (supplied) from processing-liquid supply nozzle 63a for a predetermined time (for example, 3 seconds) and the surface of wafer W contacts with first processing liquid 1. Through such a process, sulfuric acid of first processing liquid 1 enters a concave portion of an irregularity of the resist residue remained on the surface of wafer W. At this time, in order to supply first processing liquid 1 maintained at the high temperature, the temperature of first processing liquid 1 is adjusted into the high temperature, for example, at 150°, by temperature controller 63f. The temperature of the first processing liquid may be a temperature allowing sulfuric acid to chemically react with vapor/mist of water of the second processing liquid supplied in the vapor/mist supply process described later and generate Caro's acid efficiently. For example, in order to reduce the residue of the resist on the substrate efficiently, the temperature of the first processing liquid may be 140° or higher, but is not limited thereto.

Next, the liquid-film forming process including step S22 is performed. Step S22 is a step to supply the first processing liquid including sulfuric acid maintained at the high temperature onto the substrate and form the liquid film of the first processing liquid maintained at the temperature higher than room temperature on the substrate. FIG. 8B is a cross-sectional view schematically illustrating the inside of the cup when step S22 is performed.

In a state where a predetermined amount of first processing liquid 1 is discharged from processing-liquid supply nozzle 63a, spin chuck 61 and wafer W rotates at a rate (for example, 200 rpm) for a predetermined time (for example, 30 seconds), and the liquid film of first processing liquid 1 is formed on the entire surface of wafer W.

Next, the vapor/mist supply process including step S23 is performed. Step S23 is a step to supply water serving as the second processing liquid in the state of vapor or mist to the surface of the substrate on which the liquid film of sulfuric acid serving as the first processing liquid is formed. FIG. 8C is a cross-sectional view schematically illustrating the inside of the cup when step S23 is performed.

In a state where a predetermined amount of vapor or mist of the second processing liquid is discharged from vapor/mist supply device 64, spin chuck 61 and wafer W rotates at a rate (for example, 300 rpm) for a predetermined time (for example, 60 seconds), and vapor or mist of the second processing is supplied onto the entire surface of wafer W.

Here, with reference to FIG. 9, it will describe the operational effect of removing the resist residue of the substrate surface when vapor serving as the second processing liquid is supplied toward the liquid film consisting of sulfuric acid serving as the first processing liquid.

Referring to FIG. 9, the liquid film of first processing liquid 1 consisting of sulfuric acid is formed on the upper surface of wafer W that is laid on spin chuck 61.

Since first processing liquid 1 consisting of sulfuric acid supplied onto wafer W is maintained at the temperature higher than room temperature, the temperature of the liquid film formed on wafer W is same as the maintained high temperature of the first processing liquid supplied to the surface of wafer W.

If vapor is supplied to the surface of the substrate on which the liquid film maintained at the high temperature is formed, sulfuric acid of the high-temperature liquid film formed on the surface of the substrate reacts with the supplied vapor. For example, if a small amount of oxygen is contained in the high-temperature vapor, the oxygen dissociates to generate active oxygen, or high-temperature vapor itself dissociates to generate active oxygen. The active oxygen generated as described above reacts with sulfuric acid. For example, the chemical reaction identical to the reaction represented by Formula (4) in the first embodiment occurs and Caro's acid is generated.

Also, even in the present embodiment, in order to promote the chemical reaction of Formula (4), the temperature of the liquid film may be maintained at the high temperature and the supplied water in the state of vapor may be dissolved in sulfuric acid forming the liquid film. Therefore, similarly in the first embodiment, the temperature of the liquid film may be a high temperature of 100°, that is the boiling point of water, or higher. Also, the temperature of the liquid film may be a high temperature of 110° or higher, and may be 140°. As a result, since sulfuric acid reacts with active oxygen on the surface of the substrate to generate Caro's acid, it is possible to perform the substrate processing in which the reaction rate is great even without using hydrogen peroxide solution that is easily dissolved in the high temperature and the resist residue of the substrate surface is efficiently removed.

Further, even in the present embodiment, by means of repeatedly performing steps S22 and S23 in sequence, the process of forming the liquid film of the first processing liquid including sulfuric acid on the substrate and the process of supplying vapor to the surface on which the liquid film is formed can be alternately repeated. Through sequentially repeating the process of supplying first processing liquid 1 to the surface of wafer W and forming the liquid film of first processing liquid 1 on the surface of wafer W and the process of supplying vapor or mist of the second processing liquid to the surface of wafer W, first processing liquid 1 that contacts with the surface of wafer W to react chemically and have the weak reactivity can be often replaced with new non-reacted first processing liquid 1. Therefore, the concentration of a component, such as Caro's acid, effective for the substrate processing can be maintained continuously and uniformly.

Finally, step S24 is performed. Step S24 is a step to separate the substrate from the arrangement board. FIG. 8D is a cross-sectional view schematically illustrating the inside of the cup after step S24 is performed.

In a state where the supply of first processing liquid from processing-liquid supply device 63 is stopped, spin chuck 61 and wafer W rotates at the low-speed rotation (for example, 35 rpm) and deionized water is discharged from vapor/mist supply nozzle 64a or a deionized-water source (not shown) for a predetermined time (for example, 3 seconds) to wash off the first processing liquid, the second processing liquid, and the resist residue attached to the surface of wafer W.

After performing rinsing process as described above, N₂ gas is supplied (injected) from a N₂ gas supply nozzle (not shown) to the surface of wafer W to remove droplets of deionized water attached to the surface of the wafer. In this case, the temperature of N₂ gas is adjusted to be higher than room temperature through temperature controller 64g, thereby performing the drying process efficiently. Further, the drying process can be more rapidly performed through combining the rotation of wafer W and the reciprocating movement of the N₂-gas supply nozzle in a horizontal direction. After the drying process, wafer W is carried out from the upper side of spin chuck 61 and the process is finished.

(Modification of the Second Embodiment)

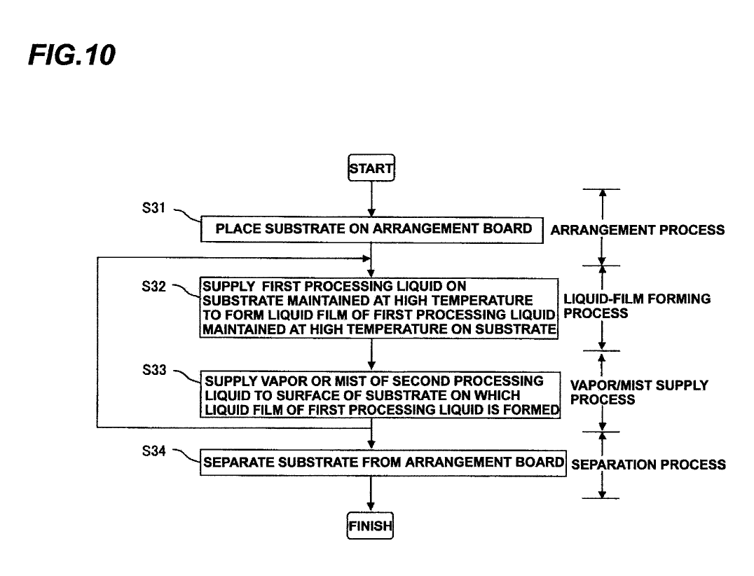

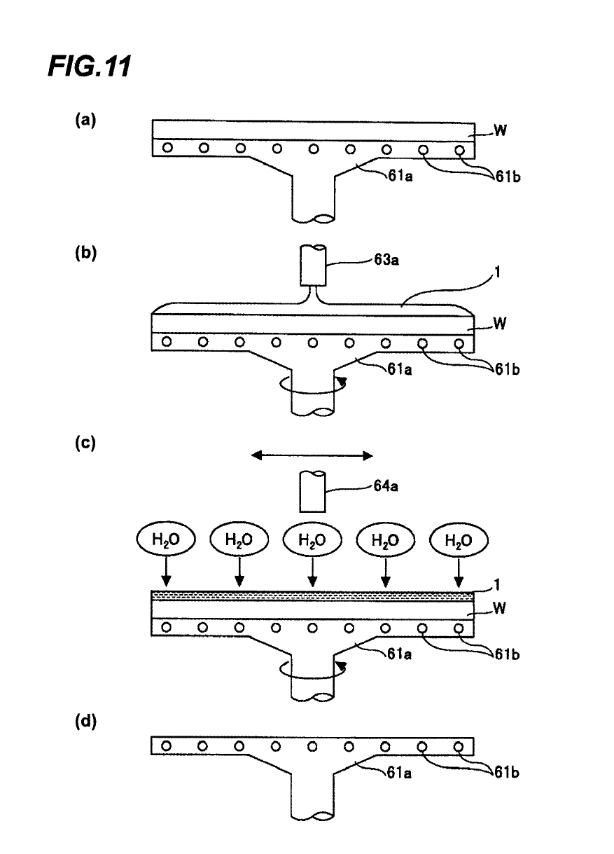

Next, the substrate processing apparatus and the substrate processing method according to modification of the second embodiment will be described with reference to FIGS. 10 and 11.

FIG. 10 is a flowchart illustrating a sequence of each process of the substrate processing method according to the present modification. FIG. 11 is a cross-sectional view schematically illustrating the inside of the cup in each process in the substrate processing method according to the present modification. The views of the inside of the cup during or after the performance of steps S31 to S34 of FIG. 10 correspond to the schematic cross-sectional views of FIGS. 11A to 11D, respectively.

The substrate processing method according to the present modification is characterized in applying the first processing liquid on the substrate maintained at the temperature higher than room temperature, instead of applying the first processing liquid maintained at the temperature higher than room temperature on the substrate, in the substrate processing apparatus and the substrate processing method according to the second embodiment.

That is, in the present modification, instead of supplying vapor maintained at the temperature higher than room temperature onto the substrate on which the liquid film of the first processing liquid consisting of sulfuric acid is formed, it is characterized in that a temperature controlling device 61b is installed at a spin chuck 61a and the temperature of the substrate laid on spin chuck 61a is controlled by heat transfer from spin chuck 61a.

The substrate processing method according to the present modification, as shown in FIG. 10, includes the arrangement process, the liquid-film forming process, the vapor/mist supply process, and the separation process. The arrangement process includes step S31, the liquid-film forming process includes step S32, the vapor/mist supply process includes step S33, and the separation process includes step S34.

First, the arrangement process including step S31 is performed. Step S31 is a step to place the substrate on spin chuck 61a that is the arrangement board. Step S31 is substantially identical to step S21 of the second embodiment. FIG. 11A is a cross-sectional view schematically illustrating the inside of the cup after step S31 is performed.

Next, the liquid-film forming process including step S32 is performed. Step S32 is a step to supply the first processing liquid including sulfuric acid onto the substrate maintained at the high temperature and form the liquid film of the first processing liquid maintained at the temperature higher than room temperature on the substrate. FIG. 11B is a cross-sectional view schematically illustrating the inside of the cup when step S32 is performed.

Step S32 is different from step S22 of the second embodiment. That is, in order to maintain the temperature of the liquid film formed on the surface of wafer W to be higher than room temperature, first processing liquid 1 forming the liquid film is maintained at the high temperature by temperature controller 63f in the second embodiment. However, wafer W on which the liquid film is formed is maintained at the high temperature, for example, 150°, by temperature controlling device 61b installed at spin chuck 61a in the present modification.

In a state of discharging a predetermined amount of first processing liquid 1 from processing-liquid supply nozzle 63a, spin chuck 61 and wafer W rotates at a number of revolutions (for example, 200 rpm) for a predetermined time (for example, 30 seconds) to form the liquid film of first processing liquid 1 on the entire surface of wafer W.

Next, the vapor/mist supply process including step S33 is performed. Step S33 is a step to supply water serving as the second processing liquid in the state of vapor or mist onto the surface of the substrate on which the liquid film of sulfuric acid serving as the first processing liquid is formed. Step S33 is substantially identical to step S23 of the second embodiment. FIG. 11C is a cross-sectional view schematically illustrating the inside of the cup when step S33 is performed.

Finally, step S34 is performed. Step S34 is a step to separate the substrate from the arrangement board. Step 34 is substantially identical to step S24 of the second embodiment. FIG. 11D is a cross-sectional view schematically illustrating the inside of the cup after step S34 is performed.

Even in the present modification, since vapor is supplied to the surface of the substrate on which the liquid film maintained at the high temperature is formed and active oxygen generated by water reacts with sulfuric acid on the surface of the substrate to generate Caro's acid, it is possible to perform the substrate processing in which the reaction rate is great even without using hydrogen peroxide solution that is easily dissolved at the high temperature and the resist residue of the substrate surface is efficiently removed.

(Third Embodiment)

The present embodiment is different from the first embodiment in that sulfuric acid is used as the first processing liquid, hydrogen peroxide solution is used as the second processing liquid, and the reaction gas is generated through the reaction of the liquid film of the high-temperature sulfuric acid and hydrogen peroxide solution. For reference, although reference number 26a in the substrate processing apparatus according to the first embodiment corresponds to the deionized-water supply pipe, reference number 26a in the substrate processing apparatus according to the present embodiment corresponds to a hydrogen-peroxide-solution supply pipe.

The first processing liquid is not specifically limited if the first processing liquid includes sulfuric acid. The second processing liquid is not specifically limited if the second processing liquid includes hydrogen peroxide solution.

Further, the vapor/mist supply device and vapor/mist supply nozzle according to the embodiments and modifications of the present disclosure correspond to a mist supply device of the present disclosure. That is, the mist supply device of the present disclosure includes a supply device to supply mist of the second processing liquid or a nozzle to supply mist of the second processing liquid.

Also, a vapor/mist supply process according to the present embodiment corresponds to a mist supply process of the present disclosure. That is, the mist supply process of the present disclosure includes supplying mist of the second processing liquid.

In the substrate processing method according to the third embodiment, only the configurations different from those of the first embodiment will be specifically described.

In the third embodiment, nitrogen gas supplied from inert-gas supply nozzle 50 controls the atmosphere. The nitrogen gas functions as buffer gas for controlling the distribution of vapor or mist of hydrogen peroxide solution to supply vapor or mist of hydrogen peroxide solution to a portion of the substrate being in contact with the liquid surface or in the vicinity of the liquid surface of the cleaning liquid. Also, the nitrogen gas functions as replacing gas for replacing the inside of processing chamber 5 in the finishing process. The nitrogen gas may prevent vapor or mist including sulfuric acid generated when supplying vapor or mist of hydrogen peroxide solution to sulfuric acid included in the liquid film which is formed on the surface of the substrate (wafer) or sulfuric acid stored in processing tank 10 from being diffused in processing chamber 5. The nitrogen gas may replace the atmosphere including sulfuric acid in processing chamber 5 with inert gas atmosphere when carrying out the substrate (wafer) from processing chamber 5. The nitrogen gas may prevent the atmosphere including sulfuric acid in processing chamber 5 from leaking out of processing chamber 5.

Further, in the present embodiment, step 14 is a step to start the supply of vapor or mist of the second processing liquid including hydrogen peroxide solution toward the vicinity of the liquid surface of the sulfuric-acid cleaning liquid.

Further, the second processing liquid can be supplied in any one form of vapor, mist, or mixture thereof. Hereinafter, the case of supplying the second processing liquid in the state of mist in the present embodiment will be described, and the case of supplying the second processing liquid in the state of vapor in the modification of the third embodiment will be described.

Opening/closing valve 29 is opened, and hydrogen peroxide solution supplied from a hydrogen-peroxide-solution supply pipe 26a is supplied toward wafer W from vapor/mist supply nozzle 40 in the state of mist. Hydrogen peroxide solution may be supplied in the state of mist including vapor through a vapor generator (not shown) installed on the route and also in the state of mist that is temperature-controlled through a temperature controller (not shown) installed on the route. Further, as described later, the temperature of vapor may be a temperature allowing a temperature of the liquid film of the first processing liquid including sulfuric acid formed on the surface of the substrate not to be lowered below the predetermined temperature. For example, the temperature of vapor may be equal to or higher than 70° and equal to or lower than 100°, but is not limited thereto.

Further, in the present embodiment, step S16 is a step to supply mist of hydrogen peroxide solution to the portion of the lifted substrate being in contact with the liquid surface or in the vicinity of the liquid surface of the sulfuric-acid cleaning liquid. In particular, mist of hydrogen peroxide solution is supplied to the vicinity of the interface between the sulfuric-acid cleaning liquid and the substrate.

If a supply rate of mist of hydrogen peroxide solution supplied from a shower supply nozzle is a predetermined value, the rate of lifting the substrate may be a rate allowing the temperature of the substrate to be almost the same as the temperature of the processing liquid stored in the processing tank. For example, the rate of lifting the substrate may be the rate of between 10 mm/sec and 50 mm/sec, but is not limited thereto.

Here, an operational effect of removing the resist residue of the substrate surface when mist of hydrogen peroxide solution is supplied toward the liquid surface of the sulfuric-acid cleaning liquid, i.e. toward the vicinity of the interface between the sulfuric-acid cleaning liquid and the substrate, will be described.

Referring to FIG. 5, the liquid film is formed on both sides of wafer W lifted from the sulfuric-acid cleaning liquid. Wafer W is gradually lifted from the sulfuric-acid cleaning liquid maintained at the high temperature. The portion of wafer hydrogen peroxide in hydrogen peroxide solution is dissolved. However, according to the present embodiment, since hydrogen peroxide solution is not maintained at the high temperature for a long time, hydrogen peroxide in hydrogen peroxide solution promptly causes the chemical reactions represented by Formulae (5) and (6) and generates Caro's acid. Therefore, it is possible to stably generate Caro's acid by using hydrogen peroxide in the high-temperature range that cannot be usually used. As a result, the substrate processing of efficiently removing the resist residue of the substrate surface can be performed.

Further, in the present embodiment, since the substrate is continuously lifted in a state where mist is supplied continuously, step S15 of the liquid-film forming process and step S16 of the vapor/mist supply process are continuously performed at the same time. However, steps SI5 and S16 can be performed in sequence if repeating the process in performing step S15 in which the supply of mist of hydrogen peroxide solution is stopped, the lift of the substrate from the sulfuric-acid cleaning liquid is stopped on the way, mist of hydrogen peroxide solution is re-supplied toward the vicinity of the liquid surface of the sulfuric-acid cleaning liquid in that state, the supply of mist of hydrogen peroxide solution is stopped, and then the substrate is lifted from the sulfuric-acid cleaning liquid again. The following processes are substantially identical to those of the substrate processing method according to the first embodiment.

According to the present embodiment, high-temperature sulfuric acid of the substrate surface reacts with hydrogen peroxide to generate Caro's acid. Therefore, the substrate processing of efficiently removing the resist residue of the substrate surface can be performed even using hydrogen peroxide solution that is easily dissolved at the high temperature.

Further, in the present embodiment, the substrate is immersed into the first processing liquid in step S13, the liquid film of the first processing liquid maintained at the temperature higher than room temperature is formed on the substrate through lifting the substrate in step S15, and vapor of the second processing liquid is supplied to the portion of the lifted substrate being in contact with the liquid surface or in the vicinity of the liquid surface of the first processing liquid in step S16. However, by means of lowering and immersing the substrate into the first processing liquid, the liquid film of the first processing liquid maintained at the temperature higher than room temperature may be formed on the substrate and mist of the second processing liquid may be supplied to the portion of the lowered substrate being in contact with the liquid surface or in the vicinity of the liquid surface of the first processing liquid. In this case, step S13 is a step to lift the substrate from the high-temperature first processing liquid stored in the processing tank or maintain the state of the lifted substrate as it is. Step S15 is a step to form the liquid film of the first processing liquid maintained at the high temperature on the substrate through immersing (lowering) the substrate into the first processing liquid. Step S16 is a step to supply mist of the second processing liquid to the portion of the immersed (lowered) substrate being in contact with the liquid surface or in the vicinity of the liquid surface of the first processing liquid.

(Modification of the Third Embodiment)

The substrate processing method according to the present modification is characterized in using vapor of hydrogen peroxide solution, instead of using mist of hydrogen peroxide solution, in the substrate processing apparatus and the substrate processing method according to the third embodiment.

That is, in the present modification, the second processing solution supplied from vapor/mist supply nozzle 40 is not supplied in the state of mist of hydrogen peroxide solution, but in the state of vapor of hydrogen peroxide solution or vapor and active oxygen generated through the dissolution of hydrogen peroxide in hydrogen peroxide solution. The temperature of vapor may be a temperature allowing a temperature of the liquid film of the first processing liquid including sulfuric acid formed on the surface of the substrate not to be decrease below the predetermined temperature. For example, if the temperature of the liquid film of the first processing liquid including sulfuric acid is 110°, the temperature of vapor can be maintained at W higher than the liquid surface of the sulfuric-acid cleaning liquid is not maintained at the high temperature. Therefore, the temperature of the portion of lifted wafer W being in contact with the liquid surface of the sulfuric-acid cleaning liquid is the same as the temperature of the sulfuric-acid cleaning liquid. However, the temperature of the portion of wafer W decreases than that of the sulfuric-acid cleaning liquid as a distance of a portion of wafer W upwardly from the liquid surface increases.

In a case where mist of hydrogen peroxide solution is supplied toward the vicinity of the liquid surface of the sulfuric-acid cleaning liquid when the substrate with the liquid film having the temperature distribution in an up and down direction is lifted from the sulfuric-acid cleaning liquid, sulfuric acid of the liquid film that is formed on the surface of the substrate and maintained at the high temperature reacts with mist of the supplied hydrogen peroxide solution. Because the portion of the substrate being in contact with the liquid surface or in the vicinity of the liquid surface of the sulfuric-acid cleaning liquid is maintained at the high temperature. Mist of the high-temperature hydrogen peroxide solution causes the chemical reaction represented by Formula (5) shown below and dissociates to generate active oxygen.

H₂SO₂→H₂O+O* Formula (5)

The generated active oxygen reacts with sulfuric acid and causes the chemical reaction represented by Formula (6) shown below to generate Caro's acid.

H₂SO₄+O*→H₂SO₅ Formula (6)

In order to promote the chemical reactions of Formulae (5) and (6), the temperature may be maintained as high as possible for increasing the reaction rate. For example, the temperature may be between 70° and 1° since hydrogen peroxide in the supplied hydrogen peroxide solution is easily dissolved in the temperature higher than 100°.

The conventional processing method in which sulfuric acid is mixed with hydrogen peroxide solution to be stored in the processing tank has a problem in that the chemical reaction represented by Formula (3) occurs at the high temperature and around 110°, but the temperature of vapor is not limited thereto.

The vapor/mist supply process according to the present modification corresponds to a mist supply process of the present disclosure. That is, the mist supply process of the present disclosure includes supplying vapor of the second processing liquid or vapor generated through the dissolution of the second processing liquid together with mist of the second processing liquid and supplying vapor of the second processing liquid or vapor generated through the dissolution of the second processing liquid into which mist of the second processing liquid supplied from the vapor/mist supply nozzle is converted on the way as well as supplying mist of the second processing liquid.

Even in the present embodiment, the operational effect of removing the resist residue of the substrate surface when supplying vapor of hydrogen peroxide solution toward the vicinity of the sulfuric-acid cleaning liquid is substantially identical to that of the third embodiment.

That is, the conventional processing method in which sulfuric acid is mixed with hydrogen peroxide solution to be stored in the processing tank has a problem in that the chemical reaction represented by Formula (3) occurs at the high temperature and hydrogen peroxide is dissolved if the concentration of hydrogen peroxide in hydrogen peroxide solution is high. However, according to the present embodiment, since hydrogen peroxide is not maintained at the high temperature for a long time, supplied hydrogen peroxide promptly causes the chemical reaction represented by Formulae (5) and (6) and generates Caro's acid. Further, even if hydrogen peroxide had been dissolved, it is possible to supply vapor and active oxygen generated through the dissolution. Therefore, it is possible to stably generate Caro's acid in a high-temperature range that cannot be usually used. As a result, the substrate processing of efficiently removing the resist residue of the substrate surface can be performed.

Further, in the present modification, the substrate is immersed into the first processing liquid in step S13, the liquid film of the first processing liquid maintained at the temperature higher than room temperature is formed on the substrate through lifting the substrate in step S15, and vapor of the second processing liquid is supplied to the portion of the lifted substrate being in contact with the liquid surface or in the vicinity of the liquid surface of the first processing liquid in step S16. However, by means of lowering and immersing the substrate into the first processing liquid, the liquid film of the first processing liquid maintained at the temperature higher than room temperature may be formed on the substrate and vapor of the second processing liquid may be supplied to the portion of the lowered substrate being in contact with the liquid surface or in the vicinity of the liquid surface of the first processing liquid. In this case, step S13 is a step to lift the substrate from the high-temperature first processing liquid stored in the processing tank or maintain the state of the lifted substrate as it is. Step S15 is a step to form the liquid film of the first processing liquid maintained at the high temperature on the substrate through immersing (lowering) the substrate into the first processing liquid. Step S16 is a step to supply vapor of the second processing liquid to the portion of the immersed (lowered) substrate being in contact with the liquid surface or in the vicinity of the liquid surface of the first processing liquid.

(Fourth Embodiment)

The present embodiment is different from the second embodiment in that sulfuric acid is used as the first processing liquid and hydrogen peroxide solution is used as the second processing liquid. However, if the first processing liquid includes sulfuric acid, it is not specifically limited. Also, if the second processing liquid includes hydrogen peroxide solution, it is not specifically limited. Other configurations are substantially identical to those of second embodiment.

In particular, the substrate processing method according to the present embodiment is almost the same as that according to the second embodiment. However, the temperature of the first processing liquid according to the present embodiment may be a temperature allowing sulfuric acid to chemically react with vapor/mist of hydrogen peroxide solution serving as the second processing liquid supplied in the vapor/mist supply process and generate Caro's acid efficiently. For example, it is possible to efficiently remove the resist residue of the substrate if the temperature of the first processing liquid is 150° or higher, but is not limited thereto.

In the present embodiment, step S23 is a step to supply hydrogen peroxide solution serving as the second processing liquid in the state of vapor or mist to the surface of the substrate on which the liquid film of sulfuric acid serving as the first processing liquid is formed.

The operational effect of removing the resist residue of the substrate surface when vapor of hydrogen peroxide solution serving as the second processing liquid is supplied toward the liquid film consisting of sulfuric acid serving as the first processing liquid will be described with reference to FIG. 9.

Referring to FIG. 9, the liquid film of first processing liquid 1 consisting of sulfuric acid is formed on the upper surface of wafer W laid on spin chuck 61. First processing liquid 1 consisting of sulfuric acid supplied to wafer W is maintained at the temperature higher than room temperature. Therefore, the temperature of the liquid film formed on wafer W becomes identical to the maintained high temperature in the first processing liquid supplied to the surface of wafer W.

If vapor of hydrogen peroxide solution is supplied to the surface of the substrate on which the liquid film maintained at the high temperature is formed, sulfuric acid of the high-temperature liquid film formed on the surface of the substrate reacts with vapor of the supplied hydrogen peroxide solution. High-temperature vapor of hydrogen peroxide solution causes the chemical reactions represented by Formulae (5) and (6) described in the third embodiment. The high-temperature vapor dissociates to generate active oxygen, and further reacts with sulfuric acid to generate Caro's acid.

Even in the present embodiment, in order to promote the chemical reaction of Formulae (5) and (6), the liquid film may be maintained at the high temperature and the supplied hydrogen peroxide solution may be dissolved in sulfuric acid forming the liquid film in the state of vapor as it is. For example, the temperature of hydrogen peroxide in the supplied hydrogen peroxide solution may be between 70° C. and 100° since hydrogen peroxide in the supplied hydrogen peroxide solution is easily dissolved in the temperature higher than 100°.

Further, even in the present embodiment, by means of repeatedly performing steps S22 and S23 in sequence, the process of forming the liquid film of the first processing liquid including sulfuric acid on the substrate and the process of supplying vapor or mist of hydrogen peroxide solution to the surface on which the liquid film is formed can be alternately repeated. Through sequentially repeating the process of supplying first processing liquid 1 to the surface of wafer W and forming the liquid film of first processing liquid 1 on the surface of wafer W and the process of supplying vapor or mist of the second processing liquid to the surface of wafer W, first processing liquid 1 having the weak reactivity by contacting with the surface of wafer W and reacting chemically can be often replaced with new non-reacted first processing liquid 1. Therefore, the concentration of a component, such as Caro's acid, effective for the substrate processing can be continuously and uniformly maintained. The following processes are substantially identical to those of the substrate processing method according to the second embodiment.

(Modification of the Fourth Embodiment)

The substrate processing method according to the present modification is characterized in applying the first processing liquid on the substrate that is maintained at the temperature higher than room temperature, instead of applying the first processing liquid that is maintained at the temperature higher than room temperature on the substrate, in the substrate processing apparatus and the substrate processing method according to the fourth embodiment.

That is, in the present modification, instead of supplying vapor or mist of hydrogen peroxide solution maintained at the temperature higher than room temperature onto the substrate on which the liquid film of the first processing liquid consisting of sulfuric acid is formed, it is characterized in that temperature controlling mechanism 61b is installed at spin chuck 61a and the temperature of the substrate laid on spin chuck 61a is controlled through heat transfer from spin chuck 61a.

The substrate processing method according to the present modification is almost identical to that according to the modification of the second embodiment. Hereinafter, only the configuration different from those of the modification of the second embodiment will be described.

In the present modification, step S33 is a step to supply hydrogen peroxide solution serving as the second processing liquid in the state of vapor or mist to the surface of the substrate on which the liquid film of sulfuric acid serving as the first processing liquid is formed. Step S33 is substantially identical to step S23 of the fourth embodiment.

Even in the present modification, vapor of hydrogen peroxide solution is supplied to the substrate surface on which the liquid film maintained at the high temperature is formed and active oxygen generated by hydrogen peroxide solution reacts with sulfuric acid on the surface of the substrate to generate Caro's acid. Therefore, it is possible to perform the substrate processing in which the reaction rate is great even using hydrogen peroxide solution that is easily dissolved at the high temperature and the resist residue of the substrate surface is efficiently removed.

The semiconductor wafer is exemplified as the to-be-processed substrate in the embodiments, but the to-be-processed substrate is not limited thereto. The various substrates, such as a LCD substrate, a glass substrate, and a ceramic substrate, may be employed as the to-be-processed substrate.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate processing apparatus to process a substrate by using a first processing liquid including sulfuric acid and a second processing liquid including water, the apparatus comprising:
a liquid-film forming device to form a liquid film of the first processing liquid maintained at a temperature higher than room temperature on at least one surface of the substrate; and
a vapor/mist supply device to supply vapor or mist of the second processing liquid to the surface of the substrate on which the liquid film of the first processing liquid is formed.

2. The substrate processing apparatus of claim 1, the liquid-film forming device comprising:
a processing tank to store the first processing liquid at the temperature higher than room temperature;
a processing chamber to process the substrate by using the first processing liquid and the second processing liquid, the processing chamber being disposed above the processing tank; and
a substrate elevating mechanism to move the substrate up and down between the processing tank and the processing chamber,
wherein the vapor/mist supply device supplies vapor or mist of the second processing liquid to a portion of the substrate in the vicinity of the liquid surface of the first processing liquid stored in the processing tank when the substrate is lifted from or immersed into the processing tank by the substrate elevating mechanism.

3. The substrate processing apparatus of claim 2, the apparatus further comprising:
an external tank to receive the first processing liquid overflowed from the processing tank; and
a processing-liquid circulating device to collect the first processing liquid from the external tank and return the first processing liquid to the processing tank.

4. The substrate processing apparatus of claim 3, wherein the vapor/mist supply device is installed in the vicinity of the liquid surface of the first processing liquid stored in the processing tank within the processing chamber.

5. The substrate processing apparatus of claim 4, wherein the apparatus further comprises an inert-gas supply device installed within the processing chamber, and the inert-gas supply device supplies inert gas into the processing chamber.

6. The substrate processing apparatus of claim 5, wherein the inert-gas supply device is installed above the vapor/mist supply device.

7. The substrate processing apparatus of claim 1, the liquid-film forming device comprising:
an arrangement board on which the substrate is laid; and
a processing-liquid supply device to supply the first processing liquid maintained at the temperature higher than room temperature to the substrate laid on the arrangement board,
wherein the processing-liquid supply device supplies the first processing liquid onto the substrate laid on the arrangement board to form the liquid film of the first processing liquid maintained at the temperature higher than room temperature on the substrate.

8. The substrate processing apparatus of claim 1, the liquid-film forming device comprising:
an arrangement board to maintain the substrate at the temperature higher than room temperature, the substrate being laid on the arrangement board; and
a processing-liquid supply device to supply the first processing liquid to the substrate laid on the arrangement board,
wherein the processing-liquid supply device supplies the first processing liquid to the substrate laid on the arrangement board to form the liquid film of the first processing liquid maintained at the temperature higher than room temperature on the substrate.

9. A substrate processing method to process a substrate by using a first processing liquid including sulfuric acid and a second processing liquid including water, the method comprising:
forming a liquid film of the first processing liquid maintained at a temperature higher than room temperature on at least one surface of the substrate; and
supplying vapor or mist of the second processing liquid to the surface of the substrate on which the liquid film of the first processing liquid is formed.

10. The substrate processing method of claim 9, wherein forming the liquid film comprises immersing the substrate into or lifting the substrate from the first processing liquid maintained at the temperature higher than room temperature to form the liquid film of the first processing liquid maintained at the temperature higher than room temperature on the substrate, and supplying vapor or mist comprises supplying vapor or mist of the second processing liquid to a portion of the substrate in the vicinity of the liquid surface of the first processing liquid.

11. The substrate processing method of claim 10, wherein the method further comprises supplying inert gas to a processing chamber, and the process chamber hermetically processes the substrate.

12. The substrate processing method of claim 11, wherein the inert gas is supplied from an area above a vapor/mist supply device to supply vapor or mist of the second processing liquid.

13. The substrate processing method of claim 9, wherein forming the liquid film comprises applying the first processing liquid maintained at the temperature higher than room temperature on the substrate to form the liquid film of the first processing liquid maintained at the temperature higher than room temperature on the substrate.

14. The substrate processing method of claim 9, wherein forming the liquid film comprises applying the first processing liquid on the substrate maintained at the temperature higher than room temperature to form the liquid film of the first processing liquid maintained at the temperature higher than room temperature on the substrate.

15. A substrate processing apparatus to process a substrate by using a first processing liquid including sulfuric acid and a second processing liquid including hydrogen peroxide solution, the apparatus comprising:
a processing tank to store the first processing liquid at a temperature higher than room temperature;
a processing chamber to process the substrate by using the first processing liquid and the second processing liquid, the processing chamber being disposed above the processing tank;
a substrate elevating mechanism to move the substrate up and down between the processing tank and the processing chamber; and
a mist supply device to supply mist of the second processing liquid to a portion of the substrate in the vicinity of the liquid surface of the first processing liquid stored in the processing tank when the substrate is lifted from or immersed into the processing tank by the substrate elevating mechanism.

16. The substrate processing apparatus of claim 15, the apparatus further comprising:
an external tank to receive the first processing liquid overflowed from the processing tank; and
a processing-liquid circulating device to collect the first processing liquid from the external tank and return the first processing liquid to the processing tank.

17. The substrate processing apparatus of claim 16, wherein the mist supply device is installed in the vicinity of the liquid surface of the first processing liquid stored in the processing tank within the processing chamber.

18. The substrate processing apparatus of claim 17, wherein the apparatus further comprises an inert-gas supply device installed within the processing chamber, and the inert-gas supply device supplies inert gas into the processing chamber.

19. The substrate processing apparatus of claim 18, wherein the inert-gas supply device is installed above the mist supply device.

20. A substrate processing method to process a substrate by using a first processing liquid including sulfuric acid and a second processing liquid including hydrogen peroxide solution, the method comprising:
forming a liquid film of the first processing liquid maintained at a temperature higher than room temperature on the substrate by immersing the substrate into or lifting the substrate from the first processing liquid maintained at the temperature higher than room temperature; and
supplying mist of the second processing liquid to a portion of the substrate in the vicinity of the liquid surface of the first processing liquid.

21. The substrate processing method of claim 20, wherein the method further comprises supplying inert gas into a processing chamber, and the processing chamber hermetically processes the substrate.

22. The substrate processing method of claim 21, wherein the inert gas is supplied from an area above a mist supply device to supply mist of the second processing liquid.
